(19) United States
(12) Patent Application Publication
(10) Pub. No.: US 2019/0244485 A1
(43) Pub. Date: Aug. 8, 2019

(54) SOCIAL WAGERING FOR LIVE SPORTING EVENTS

(71) Applicant: BALLR LIMITED, Centrak Hong Kong (HK)

(72) Inventor: Samuel JONES, Freshwater (AU)

(21) Appl. No.: 16/318,861

(22) PCT Filed: Jul. 21, 2017
(86) PCT No.: PCT/IB2017/001049

§ 371 Date: Jan. 18, 2019

Related U.S. Application Data
(60) Provisional application No. 62/365,900, filed on Jul. 22, 2016.

(51) Int. Cl. G07F 17/32; G06Q 50/00

(52) U.S. Cl. CPC G07F 17/3288; G06Q 50/01; H04L 63/0884; G07F 17/3244; G07F 17/3279

(57) ABSTRACT

Disclosed are social wagering systems creating a social wagering application for live sporting events comprising: software module configured to allow a user to create, update, and manage a player account; software module configured to allow the user to choose sporting teams and choose from in-play or upcoming sporting events; software module configured to allow the user to choose players as selected game-players for each sub-period; software module configured to award points to the user upon the chosen game-player's all positive and negative scoring player-events during each sub-period, and to calculate the user's total points for the whole chosen sporting event based on the sum of awarded points to the user of all sub-periods; and software module configured to rank the user among all users based on the total points, and to award the user one or more of prizes, experiences and wagering tokens based on the user's ranking.

### CROSS-REFERENCE

This application claims the benefit of U.S. provisional application Ser. No. 62/365,900, filed on Jul. 22, 2016, which is herein incorporated by reference in its entirety.

### BACKGROUND OF THE INVENTION

Sporting events are broadcast live both online and on traditional TV. While different sports vary in popularity in various regions, sports are an important aspect of nearly every society. At the same time, powerful mobile computing devices capable of executing applications are approaching ubiquity.

### SUMMARY OF THE INVENTION

Current technologies for online wagering pertaining to sporting events focus on the final results, or a few similar important parameters around odds and spreads. This generates tremendous revenue within the industry; however, it does not help fill a sports spectator's time during the game and may not engage the spectator's whole attention. This problem is especially true for those sports traditionally including long game play and significant slow periods during play such as cricket, baseball, golf, and tennis. Even for more intense sporting events such as American football and NASCAR, though play progresses rapidly, the natural breaks created by each small session, such as one play or one lap, gives viewers relatively big chunk of time to reflect on the last session and predict the outcomes of next session.

The subject matter presented herein provides sporting event viewers an opportunity to choose players in each sub-period of a chosen sporting event and bet on that player's performance within that sub-period. For example, while watching a basketball game, a user would be able to bet on different players during every 4 minutes of the game of 48 minutes. Whenever a chosen player passes, assists, scores, steals or rebounds during that specific 4-minute period, the user will be awarded positive points of the chosen player's performance. Accordingly, whenever the chosen player fouls, turnsover, or fails to defend opposing players during the specific 4-minute period, the user will be awarded negative points for the chosen player's performance. Similarly, while watching a soccer game, a user would be able to bet on a player (be it a goalkeeper, a defender, a midfielder, or a forward) for the player's performance during each 5-minute period. On one hand, this more fully engages the viewer's time; while on the other hand, this wagering on different players' performance during sub-periods of a sporting event would make a viewer more engaging into the sporting event. Moreover, the wagering disclosed herein is optionally social wagering, conducted among individuals who have opted to create a social relationship within the virtual world of the application. This social aspect, especially in combination with a token economy and leaderboards, furthers spectator engagement.

In one aspect, disclosed herein is a computer-implemented social wagering system, comprising: a digital processing device comprising: at least one processor, an operating system configured to perform executable instructions, a memory, and a computer program including instructions executable by the digital processing device to create a social wagering application for live sporting events comprising: a software module configured to allow a user to create, update, and manage a user account; a software module configured to allow the user to choose a favorite sporting team and to follow one or more other sporting teams wherein a sporting team comprises two or more players; a software module configured to allow the user to choose from in-play or upcoming sporting events of a selected sporting team to play a social wagering game; a software module configured to divide the whole playing period of the chosen sporting event into sub-periods and to allow the user to choose players as selected game-players for each sub-period; a database storing scoring rules parameters comprising player-events occurred during sporting events and positive or negative scoring points for each player-event, wherein scoring points are varied for players playing at different positions; a software module configured to award points to the user upon the chosen game-player's all positive and negative scoring player-events during each sub-period, and to calculate the user's total points for the whole chosen sporting event based on the sum of awarded points to the user of all sub-periods; and a software module configured to rank the user among all users of the chosen sporting event based on the total points, and to award the user one or more of prizes, experiences and wagering tokens based on the user's ranking. In some embodiments, each player is allowed to be chosen as a game-player only once for all sub-periods of one sporting event. In some embodiments, each player is allowed to be chosen as a game-player no more than twice for all sub-periods of one sporting event. In some embodiments, each player is allowed to be chosen as a game-player three times or more for all sub-periods of one sporting event. In some embodiments, a user account comprises profiles which include one or more of: teams, friends, scoring points and rankings. In some embodiments, a user creates a log-in account through the social wagering application. In some embodiments, a user creates a log-in account using a social networking media account. In further embodiments, the social networking media account is imported from one or more of: Facebook, YouTube, Twitter, LinkedIn, Pinterest, Google Plus+, Tumblr, Instagram, Reddit, VK, Snapchat, Flickr, Vine, Meetup, Ask.fm, Classmates, QQ, WeChat, Swarm by Foursquare, Kik, Yik Yak, Shots, Periscope, Medium, Soundcloud, Tinder, WhatsApp, Slack, Musical.ly, Peach, Blab, Email, Message, Renren, Sina Weibo, Renren, Line, and Momo. In some embodiments, the system further comprises a software module configured to allow a user to invite social networking media friends to join the social wagering application. In some embodiments, the system further comprises a software module configured to allow a user to play a chosen sporting event against participating friends and to rank the user based on the awarded points among the said participating friends. In some embodiments, the user is allowed to choose game-players ahead of an upcoming sporting event. In some embodiments, the user is allowed to choose game-players during an ongoing sporting event before each sub-period. In some embodiments, the player-events of the sporting event comprising one or more of: event score, event run, and any determinable event results. In some embodiments, a leaderboard is displayed to show all users' points and rankings, and a user's own rank among them. In some embodiments, a leaderboard is displayed to show a user's friends' points and rankings, and the user's own rank among them. In some embodiments, suitable sporting events comprise one or more of: cricket, baseball, basketball, volleyball, American football, softball, soccer, handball, ice hockey, field hockey, lacrosse, water polo, and rugby. In some embodiments, the sporting event is a soccer game. In some embodiments, the sporting event is divided into 5-minute sub-periods, and the user is allowed to choose different game-players for every 5-minute sub-period. In some embodiments, a player is allowed to be chosen twice for each half of the soccer game. In some embodiments, a player is listed as one of the positions of: a goalkeeper, a defender, a midfielder, and a forward. In some embodiments, player-events comprising one or more of: pass, offside pass, take on, foul, corner awarded, tackle, interception, turnover, save, claim, clearance, miss, post, attempt saved, goal, card, punch, good skill, aerial, challenge, ball recovery, error, smother, offside provoked, shield ball opp, foul throw-in, penalty faced, keeper sweeper, ball touch, failed to block, caught offside, blocked offside, and blocked pass. In some embodiments, player-events are awarded respective scoring points upon the position of a game-player. In some embodiments, player-events are identified by one or more specific qualifiers. In some embodiments, each specific qualifier connected with player-events is awarded respective scoring points upon the position of a game-player. In some embodiments, ads are displayed to the user at different sporting event breaks. In some embodiments, the user is allowed to purchase players as selected game-players using scoring points awarded.

In another aspect, disclosed herein are non-transitory computer-readable storage media encoded with a computer program including instructions executable by a processor to create a social wagering application for live sporting events comprising: a software module configured to allow a user to create, update, and manage a user account; a software module configured to allow the user to choose a favorite sporting team and to follow one or more other sporting teams wherein a sporting team comprises two or more players; a software module configured to allow the user to choose from in-play or upcoming sporting events of a selected sporting team to play a social wagering game; a software module configured to divide the whole playing period of the chosen sporting event into sub-periods and to allow the user to choose players as selected game-players for each sub-period; a database storing scoring rules parameters comprising player-events occurred during sporting events and positive or negative scoring points for each player-event, wherein scoring points are varied for players playing at different positions; a software module configured to award points to the user upon the chosen game-player's all positive and negative scoring player-events during each sub-period, and to calculate the user's total points for the whole chosen sporting event based on the sum of awarded points to the user of all sub-periods; and a software module configured to rank the user among all users of the chosen sporting event based on the total points, and to award the user one or more of prizes, experiences and wagering tokens based on the user's ranking. In some embodiments, each player is allowed to be chosen as a game-player only once for all sub-periods of one sporting event. In some embodiments, each player is allowed to be chosen as a game-player no more than twice for all sub-periods of one sporting event. In some embodiments, each player is allowed to be chosen as a game-player three times or more for all sub-periods of one sporting event. In some embodiments, a user account comprises profiles which include one or more of: teams, friends, scoring points and rankings. In some embodiments, a user creates a log-in account through the social wagering application. In some embodiments, a user creates a log-in account using a social networking media account. In further embodiments, the social networking media account is imported from one or more of: Facebook, YouTube, Twitter, LinkedIn, Pinterest, Google Plus+, Tumblr, Instagram, Reddit, VK, Snapchat, Flickr, Vine, Meetup, Ask.fm, Classmates, QQ, WeChat, Swarm by Foursquare, Kik, Yik Yak, Shots, Periscope, Medium, Soundcloud, Tinder, WhatsApp, Slack, Musical.ly, Peach, Blab, Email, Message, Renren, Sina Weibo, Renren, Line, and Momo. In some embodiments, the system further comprises a software module configured to allow a user to invite social networking media friends to join the social wagering application. In some embodiments, the system further comprises a software module configured to allow a user to play a chosen sporting event against participating friends and to rank the user based on the awarded points among the said participating friends. In some embodiments, the user is allowed to choose game-players ahead of an upcoming sporting event. In some embodiments, the user is allowed to choose game-players during an ongoing sporting event before each sub-period. In some embodiments, the player-events of the sporting event comprising one or more of: event score, event run, and any determinable event results. In some embodiments, a leaderboard is displayed to show all users' points and rankings, and a user's own rank among them. In some embodiments, a leaderboard is displayed to show a user's friends' points and rankings, and the user's own rank among them. In some embodiments, suitable sporting events comprise one or more of: cricket, baseball, basketball, volleyball, American football, softball, soccer, handball, ice hockey, field hockey, lacrosse, water polo, and rugby. In some embodiments, the sporting event is a soccer game. In some embodiments, the sporting event is divided into 5-minute sub-periods, and the user is allowed to choose different game-players for every 5-minute sub-period. In some embodiments, a player is allowed to be chosen twice for each half of the soccer game. In some embodiments, a player is listed as one of the positions of: a goalkeeper, a defender, a midfielder, and a forward. In some embodiments, player-events comprising one or more of: pass, offside pass, take on, foul, corner awarded, tackle, interception, turnover, save, claim, clearance, miss, post, attempt saved, goal, card, punch, good skill, aerial, challenge, ball recovery, error, smother, offside provoked, shield ball opp, foul throw-in, penalty faced, keeper sweeper, ball touch, failed to block, caught offside, blocked offside, and blocked pass. In some embodiments, player-events are awarded respective scoring points upon the position of a game-player. In some embodiments, player-events are identified by one or more specific qualifiers. In some embodiments, each specific qualifier connected with player-events is awarded respective scoring points upon the position of a game-player. In some embodiments, ads are displayed to the user at different sporting event breaks. In some embodiments, the user is allowed to purchase players as selected game-players using scoring points awarded.

In another aspect, disclosed herein is a computer-implemented method of creating a social wagering application for live sporting events comprising: providing, by a computer, an interface configured to allow a player to create, update, and manage a player account; providing, by the computer, an interface configured to allow the player to choose a favorite sporting team and to follow one or more other sporting teams wherein a sporting team comprises two or more players; providing, by the computer, an interface configured to allow the player to choose from in-play or upcoming sporting events of a selected sporting team to play a social wagering game; providing, by the computer, an interface configured to divide the whole playing period of the chosen sporting event into sub-periods and to allow the user to choose players as selected game-players for each sub-period; retrieving, by the computer, information from a database storing scoring rules parameters comprising player-events occurred during sporting events and positive or negative scoring points for each player-event, wherein scoring points are varied for players playing at different positions; providing, by the computer, an interface configured to award points to the user upon the chosen game-player's all positive and negative scoring player-events during each sub-period, and to calculate the user's total points for the whole chosen sporting event based on the sum of awarded points to the user of all sub-periods; and providing, by the computer, an interface configured to rank the user among all users of the chosen sporting event based on the total points, and to award the user one or more of prizes, experiences and wagering tokens based on the user's ranking. In some embodiments, each player is allowed to be chosen as a game-player only once for all sub-periods of one sporting event. In some embodiments, each player is allowed to be chosen as a game-player no more than twice for all sub-periods of one sporting event. In some embodiments, each player is allowed to be chosen as a game-player three times or more for all sub-periods of one sporting event. In some embodiments, a player account comprises profiles which include one or more of: teams, friends, scoring points and rankings. In some embodiments, each player is allowed to be chosen as a game-player only once for all sub-periods of one sporting event. In some embodiments, each player is allowed to be chosen as a game-player no more than twice for all sub-periods of one sporting event. In some embodiments, each player is allowed to be chosen as a game-player three times or more for all sub-periods of one sporting event. In some embodiments, a user account comprises profiles which include one or more of: teams, friends, scoring points and rankings. In some embodiments, a user creates a log-in account through the social wagering application. In some embodiments, a user creates a log-in account using a social networking media account. In further embodiments, the social networking media account is imported from one or more of: Facebook, YouTube, Twitter, LinkedIn, Pinterest, Google Plus+, Tumblr, Instagram, Reddit, VK, Snapchat, Flickr, Vine, Meetup, Ask.fm, Classmates, QQ, WeChat, Swarm by Foursquare, Kik, Yik Yak, Shots, Periscope, Medium, Soundcloud, Tinder, WhatsApp, Slack, Musical.ly, Peach, Blab, Email, Message, Renren, Sina Weibo, Renren, Line, and Momo. In some embodiments, the system further comprises a software module configured to allow a user to invite social networking media friends to join the social wagering application. In some embodiments, the system further comprises a software module configured to allow a user to play a chosen sporting event against participating friends and to rank the user based on the awarded points among the said participating friends. In some embodiments, the user is allowed to choose game-players ahead of an upcoming sporting event. In some embodiments, the user is allowed to choose game-players during an ongoing sporting event before each sub-period. In some embodiments, the player-events of the sporting event comprising one or more of: event score, event run, and any determinable event results. In some embodiments, a leaderboard is displayed to show all users' points and rankings, and a user's own rank among them. In some embodiments, a leaderboard is displayed to show a user's friends' points and rankings, and the user's own rank among them. In some embodiments, suitable sporting events comprise one or more of: cricket, baseball, basketball, volleyball, American football, softball, soccer, handball, ice hockey, field hockey, lacrosse, water polo, and rugby. In some embodiments, the sporting event is a soccer game. In some embodiments, the sporting event is divided into 5-minute sub-periods, and the user is allowed to choose different game-players for every 5-minute sub-period. In some embodiments, a player is allowed to be chosen twice for each half of the soccer game. In some embodiments, a player is listed as one of the positions of: a goalkeeper, a defender, a midfielder, and a forward. In some embodiments, player-events comprising one or more of: pass, offside pass, take on, foul, corner awarded, tackle, interception, turnover, save, claim, clearance, miss, post, attempt saved, goal, card, punch, good skill, aerial, challenge, ball recovery, error, smother, offside provoked, shield ball opp, foul throw-in, penalty faced, keeper sweeper, ball touch, failed to block, caught offside, blocked offside, and blocked pass. In some embodiments, player-events are awarded respective scoring points upon the position of a game-player. In some embodiments, player-events are identified by one or more specific qualifiers. In some embodiments, each specific qualifier connected with player-events is awarded respective scoring points upon the position of a game-player. In some embodiments, ads are displayed to the user at different sporting event breaks. In some embodiments, the user is allowed to purchase players as selected game-players using scoring points awarded.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIG. 1 shows a non-limiting example of an interface for social wagering for live sporting events; in this case, an interface allowing a user to log-in or sign-up through the social wagering application or using a social networking media account;

FIG. 2 shows a non-limiting example of an interface for social wagering for live sporting events; in this case, an interface allowing a user to view, search and connect with friends;

FIG. 3 shows a non-limiting example of an interface for social wagering for live sporting events; in this case, an interface allowing a user to pick a favorite team;

FIG. 4 shows a non-limiting example of an interface for social wagering for live sporting events; in this case, an interface allowing a user to pick other teams that he'd like to play live events;

FIG. 5 shows a non-limiting example of an interface for social wagering for live sporting events; in this case, an interface allowing a user to view and choose from in-play and upcoming sporting events;

FIG. 6 shows a non-limiting example of an interface for social wagering for live sporting events; in this case, an interface allowing a user to choose a team for a live sporting event;

FIG. 7 shows a non-limiting example of an interface for social wagering for live sporting events; in this case, an interface allowing a user to choose a team for a live sporting event and start a social wagering game;

FIG. 8 shows a non-limiting example of an interface for social wagering for live sporting events; in this case, an interface allowing a user to invite friends to play social wagering game on a live sporting event;

FIG. 9 shows a non-limiting example of an interface for social wagering for live sporting events; in this case, an interface displaying a user's play information including friends, favorite and followed teams, sporting events played, average scoring points, different rankings and access to a leaderboard;

FIG. 10 shows a non-limiting example of an interface for social wagering for live sporting events; in this case, an interface allowing a user to view and edit the settings;

FIG. 11 shows a non-limiting example of an interface for social wagering for live sporting events; in this case, loading interfaces for game playing screens;

FIG. 12 shows a non-limiting example of an interface for social wagering for live sporting events; in this case, loading interfaces for game playing screens;

FIG. 13 shows a non-limiting example of an interface for social wagering for live sporting events; in this case, a game playing screen allowing a user to choose a player for the first 5-minute sub-period;

FIG. 14 shows a non-limiting example of an interface for social wagering for live sporting events; in this case, a game playing screen allowing a user to choose a player for the second 5-minute sub-period;

FIG. 15 shows a non-limiting example of an interface for social wagering for live sporting events; in this case, a game playing screen allowing a user to choose a game-player for the third 5-minute sub-period at a future time;

FIG. 16 shows a non-limiting example of an interface for social wagering for live sporting events; in this case, a game playing screen displaying a game-player chosen for the next 5-minute sub-period;

FIG. 17 shows a non-limiting example of an interface for social wagering for live sporting events; in this case, a game playing screen displaying a chosen player's playing performance for a finished sub-period;

FIG. 18 shows a non-limiting example of an interface for social wagering for live sporting events; in this case, a game playing screen allowing a user to choose and lock a player for a sub-period;

FIG. 19 shows a non-limiting example of an interface for social wagering for live sporting events; in this case, a game playing screen displaying a locked player waiting for the assigned sub-period;

FIG. 20 shows a non-limiting example of an interface for social wagering for live sporting events; in this case, a game playing screen displaying a chosen player's live playing performance during the assigned sub-period;

FIG. 21 shows a non-limiting example of an interface for social wagering for live sporting events; in this case, a game playing screen displaying another chosen player's live playing performance during the assigned sub-period;

FIG. 22 shows a non-limiting example of an interface for social wagering for live sporting events; in this case, a game playing screen allowing a user to choose a player for the second 5-minute sub-period wherein an ad needs to be displayed before that player is viewed and chosen;

FIG. 23 shows a non-limiting example of an interface for social wagering for live sporting events; in this case, a game playing screen allowing a user to watch an ad video before choosing a certain player for the second time during one live sporting event;

FIG. 24 shows a non-limiting example of an interface for social wagering for live sporting events; in this case, a game playing screen allowing a user to watch an ad video before choosing a certain player for the second time during one live sporting event, wherein the interface displays a lock symbol and text indicating that selection of a particular player requires the user to view an ad video before the player may be selected a second time during one live sporting event;

FIG. 25 shows a non-limiting example of an interface for social wagering for live sporting events; in this case, a game playing screen allowing a user to watch an ad video before choosing a certain player for the second time during one live sporting event, wherein the interface displays a confirmation screen, prompting the user to accept watching an ad in order to choose a certain player for the second time during one live sporting event;

FIG. 26 shows a non-limiting example of an interface for social wagering for live sporting events; in this case, a game playing screen displaying a chosen player's different live playing performance and scoring points during the assigned sub-period. In this example, the player has just accumulated −100 scoring points as a result of a player-event;

FIG. 27 shows a non-limiting example of an interface for social wagering for live sporting events; in this case, a game playing screen displaying a chosen player's different live playing performance and scoring points during the assigned sub-period, wherein the player has just accumulated 120 scoring points as a result of a player-event, and wherein interface also indicates the current sub-period is a power play;

FIG. 28 shows a non-limiting example of an interface for social wagering for live sporting events; in this case, a game playing screen displaying a chosen player's different live playing performance and scoring points during the assigned sub-period, wherein the player has just accumulated 120 scoring points as a result of a player-event;

FIG. 29 shows a non-limiting example of an interface for social wagering for live sporting events; in this case, a game playing screen displaying a leaderboard, a user's total points, global rankings, and rankings among the user's friends upon the finish of a live sporting event;

FIGS. 30-41 show non-limiting examples of scoring rules for social wagering for live soccer games; in this case, rules comprising events and qualifiers names and respective scoring points of each event and qualifier for goalkeepers, defenders, midfielders and forwards;

FIG. 42 shows a non-limiting example of a digital processing device; in this case, a device with one or more CPUs, a memory, a communication interface, and a display;

FIG. 43 shows a non-limiting example of a web/mobile application provision system; in this case, a system providing browser-based and/or native mobile player interfaces;

FIG. 44 shows a non-limiting example of a cloud-based web/mobile application provision system; in this case, a system comprising an elastically load balanced, auto-scaling web server and application server resources as well synchronously replicated databases; and

FIG. 45 shows a non-limiting example of a social wagering platform; in this case, a platform providing social wagering application for live sporting events wherein the system comprises consumer device 4520, wagering services servers 4510 and sports service providers 4500 inter-connecting with each other.

### DETAILED DESCRIPTION OF THE INVENTION

Described herein, in certain embodiments, is a computer-implemented social wagering system, comprising: a digital processing device comprising: at least one processor, an operating system configured to perform executable instructions, a memory, and a computer program including instructions executable by the digital processing device to create a social wagering application for live sporting events comprising: a software module configured to allow a user to create, update, and manage a user account; a software module configured to allow the user to choose a favorite sporting team and to follow one or more other sporting teams wherein a sporting team comprises two or more players; a software module configured to allow the user to choose from in-play or upcoming sporting events of a selected sporting team to play a social wagering game; a software module configured to divide the whole playing period of the chosen sporting event into sub-periods and to allow the user to choose players as selected game-players for each sub-period; a database storing scoring rules parameters comprising player-events occurred during sporting events and positive or negative scoring points for each player-event, wherein scoring points are varied for players playing at different positions; a software module configured to award points to the user upon the chosen game-player's all positive and negative scoring player-events during each sub-period, and to calculate the user's total points for the whole chosen sporting event based on the sum of awarded points to the user of all sub-periods; and a software module configured to rank the user among all users of the chosen sporting event based on the total points, and to award the user one or more of prizes, experiences and wagering tokens based on the user's ranking.

Also described herein, in certain embodiments, are non-transitory computer-readable storage media encoded with a computer program including instructions executable by a processor to create a social wagering application for live sporting events comprising: a software module configured to allow a user to create, update, and manage a user account; a software module configured to allow the user to choose a favorite sporting team and to follow one or more other sporting teams wherein a sporting team comprises two or more players; a software module configured to allow the user to choose from in-play or upcoming sporting events of a selected sporting team to play a social wagering game; a software module configured to divide the whole playing period of the chosen sporting event into sub-periods and to allow the user to choose players as selected game-players for each sub-period; a database storing scoring rules parameters comprising player-events occurred during sporting events and positive or negative scoring points for each player-event, wherein scoring points are varied for players playing at different positions; a software module configured to award points to the user upon the chosen game-player's all positive and negative scoring player-events during each sub-period, and to calculate the user's total points for the whole chosen sporting event based on the sum of awarded points to the user of all sub-periods; and a software module configured to rank the user among all users of the chosen sporting event based on the total points, and to award the user one or more of prizes, experiences and wagering tokens based on the user's ranking.

Also described herein, in certain embodiments, is a computer-implemented method of creating a social wagering application for live sporting events comprising: providing, by a computer, an interface configured to allow a player to create, update, and manage a player account; providing, by the computer, an interface configured to allow the player to choose a favorite sporting team and to follow one or more other sporting teams wherein a sporting team comprises two or more players; providing, by the computer, an interface configured to allow the player to choose from in-play or upcoming sporting events of a selected sporting team to play a social wagering game; providing, by the computer, an interface configured to divide the whole playing period of the chosen sporting event into sub-periods and to allow the user to choose players as selected game-players for each sub-period; retrieving, by the computer, information from a database storing scoring rules parameters comprising player-events occurred during sporting events and positive or negative scoring points for each player-event, wherein scoring points are varied for players playing at different positions; providing, by the computer, an interface configured to award points to the user upon the chosen game-player's all positive and negative scoring player-events during each sub-period, and to calculate the user's total points for the whole chosen sporting event based on the sum of awarded points to the user of all sub-periods; and providing, by the computer, an interface configured to rank the user among all users of the chosen sporting event based on the total points, and to award the user one or more of prizes, experiences and wagering tokens based on the user's ranking.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Social Wagering Platform

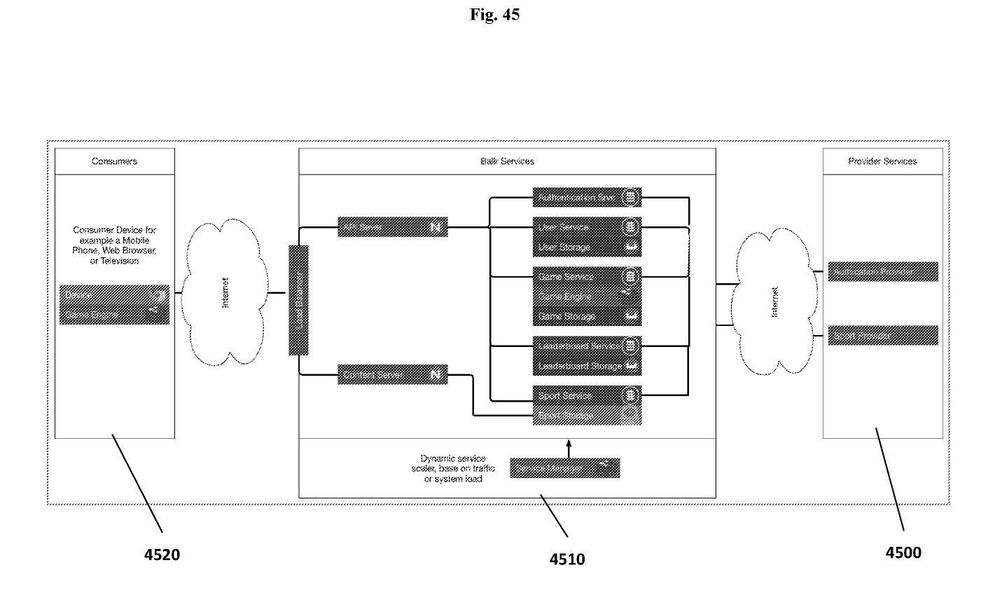

The platforms, systems, media, and methods described herein include a social wagering platform, or use of the same. Referring to FIG. 45, in a particular embodiment, a social wagering frame is described to provide social wagering application for live sporting events wherein the system comprises consumer device 4520, wagering service servers 4510 and sports service providers 4500 inter-connecting with each other.

In some embodiments, a user uses a consumer device to connect to wagering services servers. In some embodiments, a consumer device is one or more of: a mobile device, a web browser, and a television. In further embodiments, a mobile consumer device comprises one or more of: Android, iOS and Windows Mobile. In some embodiments, a consumer device provides an interface to allow a user to create, update, and manage a user account. In some embodiments, a consumer device provides an interface to allow a user to choose from in-play or upcoming sporting events to play prediction wagering game. In some embodiments, a consumer device provides an interface to make predictions and place wagering tokens on outcomes of one or more small parts of a chosen sporting event before each said small part happens. In some embodiments, a consumer device provides an interface to display a user's points, rankings, prizes, experiences and wagering tokens. In some embodiments, a consumer device provides an interface to allow a user to invite social networking media friends to join the social wagering application. In some embodiments, a consumer device provides an interface to allow a user to play a chosen sporting event against participating friends and to rank the user based on the awarded points among the said participating friends.

In some embodiments, wagering services servers connect to consumer device and provide social wagering application for live sporting events to users using consumer devices. In some embodiments, wagering services servers connect to sporting services providers to get outcomes of sporting events. In some embodiments, wagering services servers comprise a load balancer and a service manager. In some embodiments, a service manager comprises an API server and a content server. In further embodiments, an API server comprising one or more of services: Authentication Service, User Service, User Storage, Game service, Game Engine, Leaderboard Service, Leaderboard Storage and Sport Service, provides social wagering application to consumer devices. In further embodiments, a content server comprises Sport Storage to retrieve services from sporting services providers.

In some embodiments, a sporting services provider comprises an Authentication Provider upon the request by wagering services servers and provides sports outcomes to the wagering services servers.

### Social Wagering System

The platforms, systems, media, and methods described herein include a social wagering system, or use of the same. In some embodiments, a social wagering system comprises a digital processing device comprising: at least one processor, an operating system configured to perform executable instructions, a memory, and a computer program including instructions executable by the digital processing device to create a social wagering application.

In some embodiments, a social wagering application comprises a software module configured to allow a user to create, update, and manage a player account. In further embodiments, a social wagering application comprises a software module configured to allow the user to choose a favorite sporting team and to follow one or more other sporting teams wherein a sporting team comprises two or more players. In further embodiments, a social wagering application comprises a software module configured to allow the user to choose from in-play or upcoming sporting events of a selected sporting team to play a social wagering game. In further embodiments, a social wagering application comprises a software module configured to divide the whole playing period of the chosen sporting event into sub-periods and to allow the user to choose players as selected game-players for each sub-period. In further embodiments, a social wagering application comprises a software module configured to retrieve scoring information from a database storing scoring rules parameters comprising player-events occurred during sporting events and positive or negative scoring points for each player-event, wherein scoring points are varied for players playing at different positions. In further embodiments, a social wagering application comprises a software module configured to award points to the user upon the chosen game-player's all positive and negative scoring player-events during each sub-period, and to calculate the user's total points for the whole chosen sporting event based on the sum of awarded points to the user of all sub-periods. In further embodiments, a social wagering application comprises a software module configured to rank the user among all users of the chosen sporting event based on the total points, and to award the user one or more of prizes, experiences and wagering tokens based on the user's ranking.

In some embodiments, a social wagering application further comprises a software module configured to allow a player to invite social networking media friends to join the social wagering application. In some embodiments, a social wagering application further comprises a software module configured to allow a player to play a chosen sporting event against participating friends and to rank the player based on the awarded points among the said participating friends.

### User Account and Friend

In some embodiments, the platforms, systems, media, and methods described herein include a user's account, or use of the same. In some embodiments, a user is allowed to create, update, and manage a player account. In some embodiments, a user account comprises profiles which include one or more of: achievements, friends, teams, and play history. In some embodiments, a user is allowed to add a photo, choose a favorite team, follow other teams, view the user's overall game average, and view the user's position on a favorite team leaderboard and the user's position within a friend group.

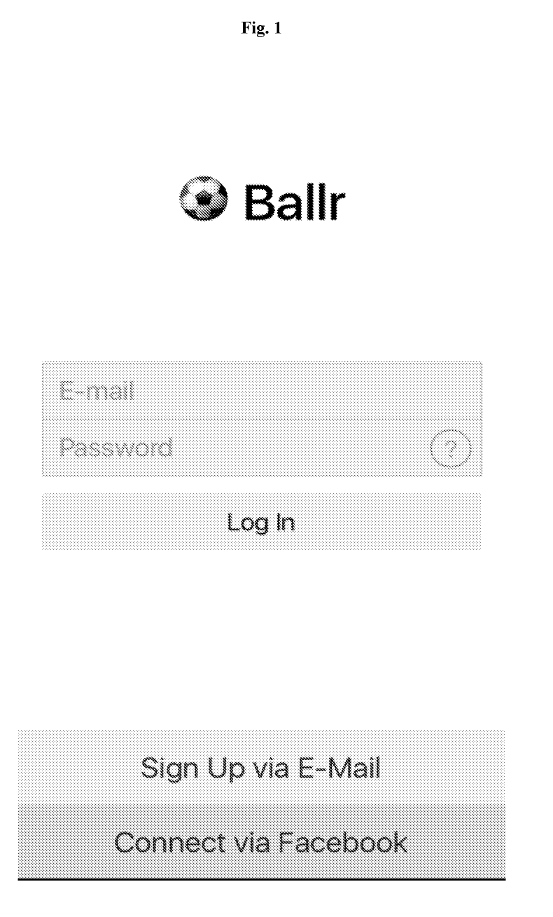

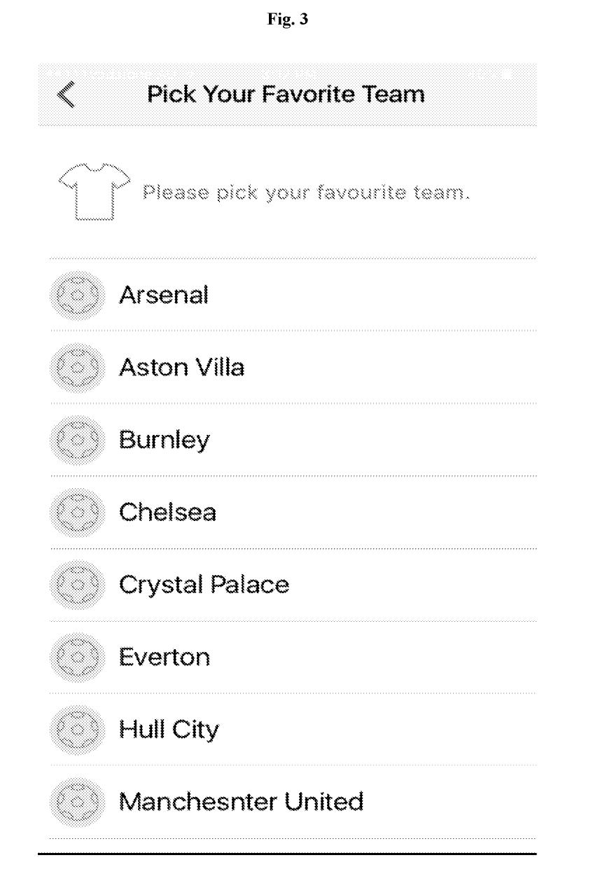

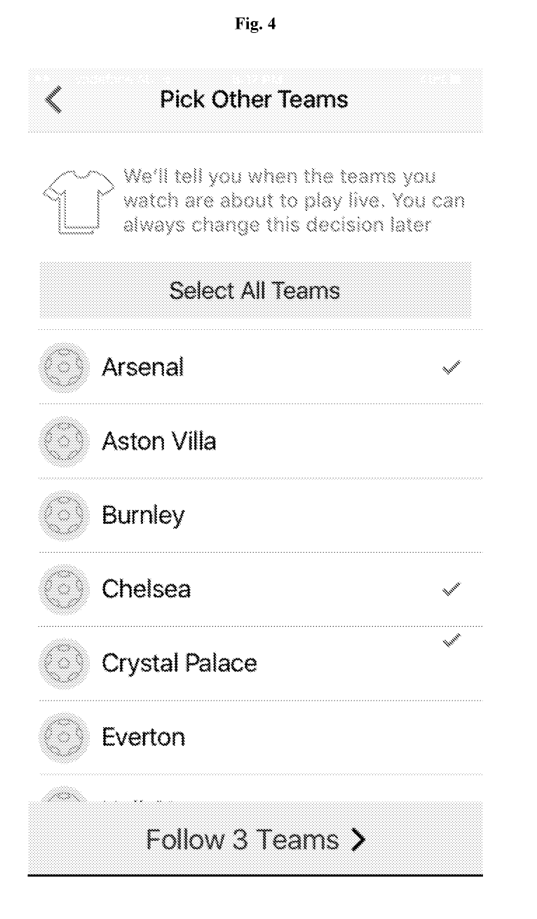

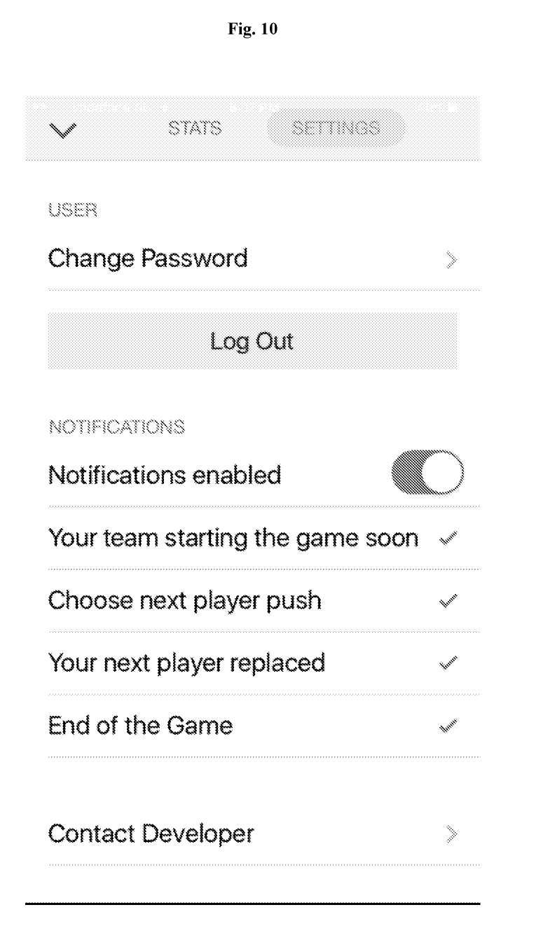

Referring to FIG. 1, in a particular embodiment, an interface is provided to allow a user to log-in or sign-up through the social wagering application or using a social networking media account. Referring to FIG. 3, in a particular embodiment, an interface is provided to allow a user to pick a favorite team. Referring to FIG. 4, in a particular embodiment, an interface is provided to allow a user to pick other teams that he'd like to play live events. Referring to FIG. 10, in a particular embodiment, an interface is provided to allow a user to view and edit the settings.

In some embodiments, a user is notified when the user's favorite team or followed teams are about to start playing a live sporting event. In some embodiments, a user is notified when the user's favorite team or followed teams are playing a live sporting event.

In some embodiments, a user creates a log-in account through the social wagering application. In some embodiments, a user creates a log-in account using a social networking media account. In further embodiments, the social networking media account is imported from one or more of: Facebook, YouTube, Twitter, LinkedIn, Pinterest, Google Plus+, Tumblr, Instagram, Reddit, VK, Snapchat, Flickr, Vine, Meetup, Ask.fm, Classmates, QQ, WeChat, Swarm by Foursquare, Kik, Yik Yak, Shots, Periscope, Medium, Soundcloud, Tinder, WhatsApp, Slack, Musical.ly, Peach, Blab, Email, Message, Renren, Sina Weibo, Renren, Line, and Momo.

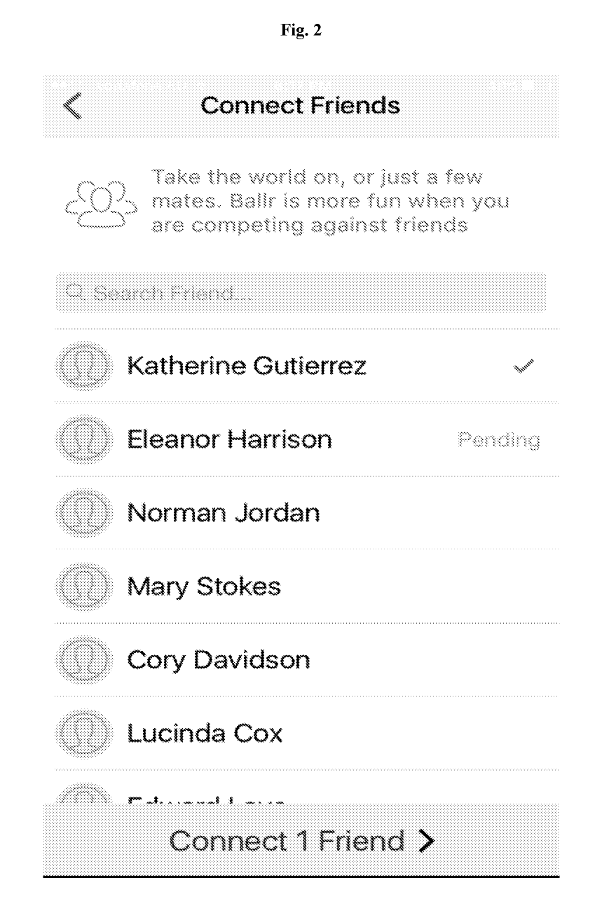

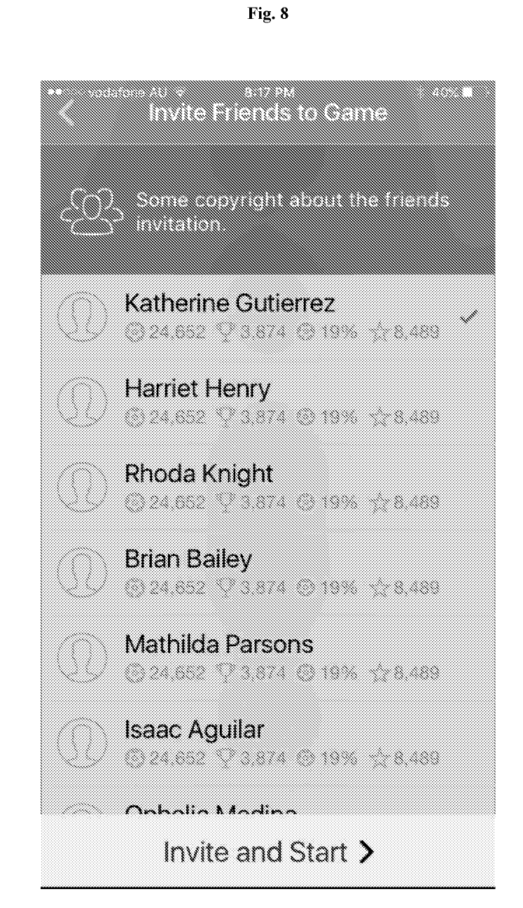

In some embodiments, the platforms, systems, media, and methods described herein include a player's friend, or use of the same. In some embodiments, the social wagering system further comprises a software module configured to allow a user to invite social networking media friends to join the social wagering application. In some embodiments, the social wagering system further comprises a software module configured to allow a user to play a chosen sporting event against participating friends and to rank the player based on the awarded points among the said participating friends. Referring to FIG. 2, in a particular embodiment, an interface is provided to allow a user to view, search and connect with friends. Referring to FIG. 8, in a particular embodiment, an interface is provided to allow a user to invite friends to play social wagering game on a live sporting event.

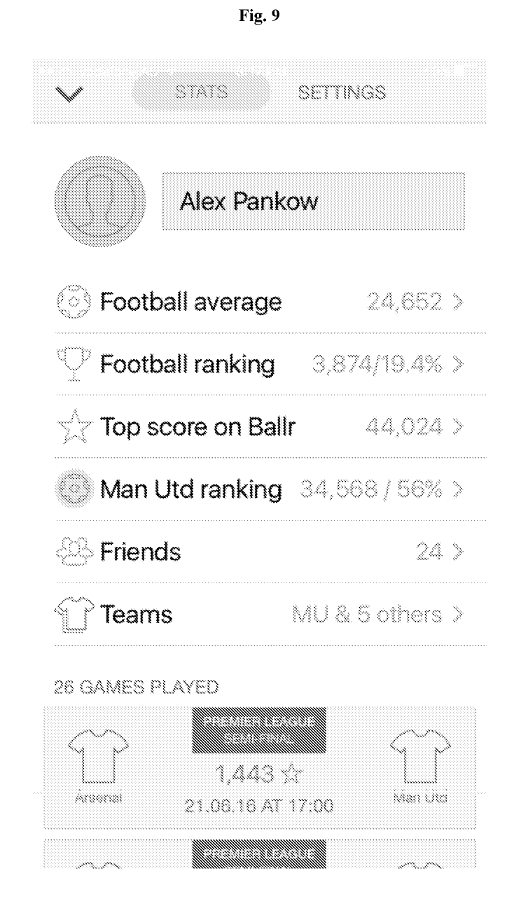

Referring to FIG. 9, in a particular embodiment, an interface is provided to display a user's play information including friends, favorite and followed teams, sporting events played, average scoring points, and different rankings.

In some embodiments, a user plays the social wagering game at a private community; for example, a bar with 500 patrons. In other embodiments, a user plays the social wagering game at a stadium with 100,000 attendees. In some embodiments, a software module is configured to allow a user to enter this “stadium” environment within the social wagering environment with a code. In further embodiments, this “stadium” environment provides a leaderboard and prizes of its own for those within this “stadium” environment. In some embodiments, a TV station is qualified as a “stadium” environment when all its viewers receive a code from the TV station. In further embodiments, a user enters into a private game while using the code from the TV station.

### Sporting Events

The platforms, systems, media, and methods described herein include sporting events, or use of the same. In some embodiments, sporting events comprise one or more of: cricket, boxing, baseball, basketball, American football, softball, soccer, auto racing, NASCAR, Formula 1, cycling, snooker, handball, wrestling, skiing, swimming, horse racing, track and fields, snooker, billiards, motor biking, diving, shooting, archery, fencing, judo, taekwondo, golf, tennis, badminton, table tennis, ice hockey, field hockey, volleyball, lacrosse, water polo, and rugby. In some embodiments, soccer will be understood to mean association football, or simply football, and is distinct from the sport of American football. As used herein, the terms football and soccer are used interchangeably.

In some embodiments, a user is allowed to choose from in-play or upcoming sporting events to play a social wagering game. In some embodiments, a sporting event comprises a playing period for the whole event. For example, a basketball game requires 48 minutes; an American football game requires 60 minutes; and a soccer game requires 90 minutes. In some embodiments, a software module is configured to divide the whole playing period of the chosen sporting event into sub-periods. For example, in particular embodiments, a basketball game is divided into twelve 4-minute sub-periods; an American football game is divided into twelve 5-minute sub-periods; a soccer game is divided into eighteen 5-minute sub-periods.

In some embodiments, a user is allowed to choose players from a selected team as selected game-players for each sub-period. In some embodiments, each player is allowed to be chosen as a game-player only once for all sub-periods of one sporting event. In some embodiments, each player is allowed to be chosen as a game-player no more than twice for all sub-periods of one sporting event. In some embodiments, each player is allowed to be chosen as a game-player three times or more for all sub-periods of one sporting event. In some embodiments, a user is allowed to choose game-players ahead of an upcoming sporting event. In some embodiments, a user is allowed to choose game-players during an ongoing sporting event before each sub-period.

In some embodiments, a database is configured to store scoring rules parameters comprising player-events occurred during sporting events and positive or negative scoring points for each player-event, wherein scoring points are varied for players playing at different positions. In some embodiments, a software module is configured to award points to the user upon the chosen game-player's all positive and negative scoring player-events during each sub-period, and to calculate the user's total points for the whole chosen sporting event based on the sum of awarded points to the user of all sub-periods.

In some embodiments, a sporting event is a soccer game. In further embodiments, the sporting event is divided into 5-minute sub-periods, and the user is allowed to choose different game-players for every 5-minute sub-period. In further embodiments, a player is allowed to be chosen twice for each half of the soccer game.

### Players

The platforms, systems, media, and methods described herein include a player, or use of the same. In some embodiments, a sporting event is played by two opposing teams including multiple players. For example, at a given time, a basketball game is played by two teams of 5 players; an American football game is played by two teams of 11 players; a soccer game is played between two teams of 11 players.

In some embodiments, a player is listed as different positions on the field/court. For example, a basketball player is listed as one of: a center, a power forward, a small forward, a shooting guard, and a point guard; a soccer player is listed as one of the positions of: a goalkeeper, a defender, a midfielder, and a forward.

In some embodiments, a software module is configured to divide the whole playing period of the chosen sporting event into sub-periods. For example, in particular embodiments, a basketball game is divided into twelve 4-minute sub-periods; an American football game is divided into twelve 5-minute sub-periods; a soccer game is divided into eighteen 5-minute sub-periods. In some embodiments, a user is allowed to choose players from a selected team as selected game-players for each sub-period.

In some embodiments, a player makes all kinds of plays and incurs player-events that are awarded positive or negative scoring points. In some embodiments, scoring points for the same player-event are different for players at different positions. For example, in a particular embodiment of a soccer game, while a goalkeeper is awarded 250,000 points for scoring a goal; a defender is awarded 25,000 points; 15,000 points for a midfielder; and 10,000 points for a forward.

### Game-Players

The platforms, systems, media, and methods described herein include a game-player, or use of the same. In some embodiments, a software module is configured to divide the whole playing period of the chosen sporting event into sub-periods. For example, in particular embodiments, a basketball game is divided into twelve 4-minute sub-periods; an American football game is divided into twelve 5-minute sub-periods; a soccer game is divided into eighteen 5-minute sub-periods.

In some embodiments, a user is allowed to choose players from a selected team as selected game-players for each sub-period. In some embodiments, each player is allowed to be chosen as a game-player only once for all sub-periods of one sporting event. In some embodiments, each player is allowed to be chosen as a game-player no more than twice for all sub-periods of one sporting event. In some embodiments, each player is allowed to be chosen as a game-player three times or more for all sub-periods of one sporting event. In some embodiments, a user is allowed to choose game-players ahead of an upcoming sporting event. In some embodiments, a user is allowed to choose game-players during an ongoing sporting event before each sub-period.

In some embodiments, a software module is configured to award points to the user upon the chosen game-player's all positive and negative scoring player-events during each sub-period, and to calculate the user's total points for the whole chosen sporting event based on the sum of awarded points to the user of all sub-periods.

For example, for a soccer game, in a particular embodiment, the sporting event is divided into 5-minute sub-periods, and the user is allowed to choose different game-players for every 5-minute sub-period. In further embodiments, a player is allowed to be chosen twice as a game-player for each half of the soccer game.

In some embodiments, game-players are chosen from players who are playing on the field/court. For example, in a soccer game, game-players may only be chosen from the 11 players on the field; not from the beach players.

In some embodiments, a software module is configured to allow a user to view the performance of each player of the selected team in different aspects of the game.

In some embodiments, a user is allowed to purchase players as selected game-players using scoring points awarded.

### Player-Events

The platforms, systems, media, and methods described herein include a player-event, or use of the same. In some embodiments, player-events of a sporting event comprise one or more of: event score, event run, and any determinable event results. In some embodiments, a player makes all kinds of plays and incurs player-events that are awarded positive or negative scoring points.

In some embodiments, a database is configured to store scoring rules parameters comprising player-events occurred during sporting events and positive or negative scoring points for each player-event, wherein scoring points are varied for players playing at different positions. In some embodiments, a software module is configured to award points to the user upon the chosen game-player's all positive and negative scoring player-events during each sub-period, and to calculate the user's total points for the whole chosen sporting event based on the sum of awarded points to the user of all sub-periods.

In some embodiments, the live sporting event is a soccer game. In further embodiments, player-events comprise one or more of: pass, offside pass, take on, foul, corner awarded, tackle, interception, turnover, save, claim, clearance, miss, post, attempt saved, goal, card, punch, good skill, aerial, challenge, ball recovery, error, smother, offside provoked, shield ball opp, foul throw-in, penalty faced, keeper sweeper, ball touch, failed to block, caught offside, blocked offside, and blocked pass. For example, a successful long-ball pass is awarded 4,000 points; and a foul is awarded −5,000 points. Also for example, a clearance is awarded 4,000 points; but a miss is awarded −5,000 points.

In further embodiments, player-events are awarded respective scoring points based on the position of a game-player. For example, in a particular embodiment, while a goalkeeper is awarded 250,000 points for scoring a goal; a defender is awarded 25,000 points; 15,000 points for a midfielder; and 10,000 points for a forward. In some embodiments, common player-events of a goalkeeper comprise one or more of: saves, saves inside, saves outside, and catches. In some embodiments, common player-events of a defender comprise one or more of: tackles, interceptions, clearances, and pass completion. In some embodiments, common player-events of a midfielder comprise one or more of: assists, chances created, passes, and pass success. In some embodiments, common player-events of a forward comprise one or more of: shots, shots on target, chances created, and dribbles.

In further embodiments, player-events are identified by one or more specific qualifiers which further distinguish player-events. For example, a player-event of “pass” comprises different qualifiers such as: long ball pass, cross pass, head pass, through ball pass, free kick pass, corner pass, attacking pass, goal-kick pass, and throw-in pass, etc. In further embodiments, each specific qualifier connected with player-events is awarded respective scoring points upon the position of a game-player. For example, a long pass is awarded 4,000 points, but a goal kick pass is only awarded 2,500 points as it's easier and brings less to the team. For another example, a regular foul is awarded −5,000 points; while a penalty foul is awarded −50,000 points.

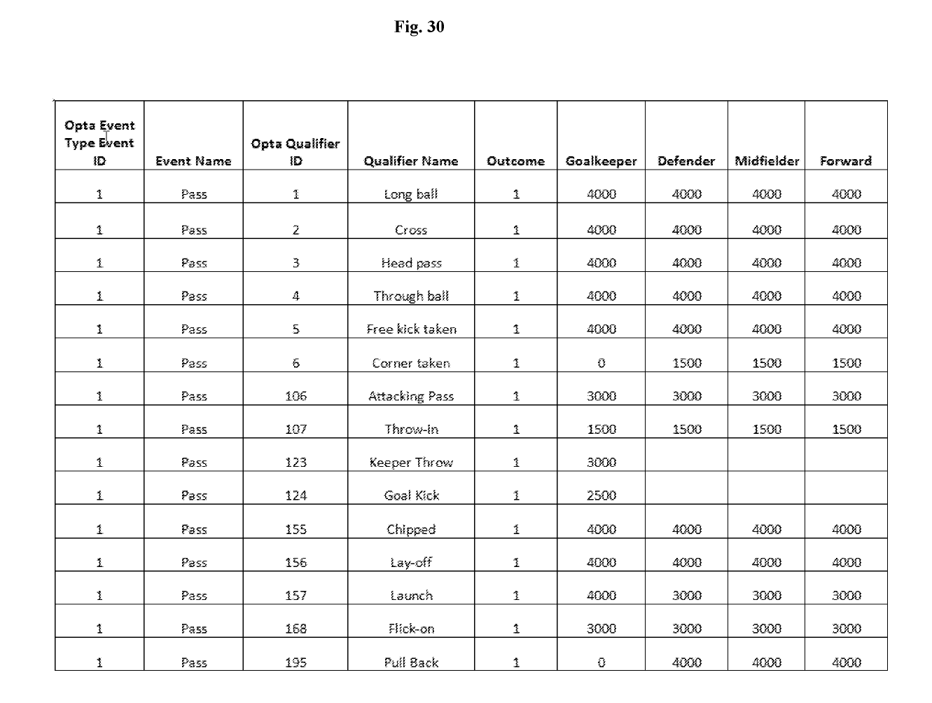

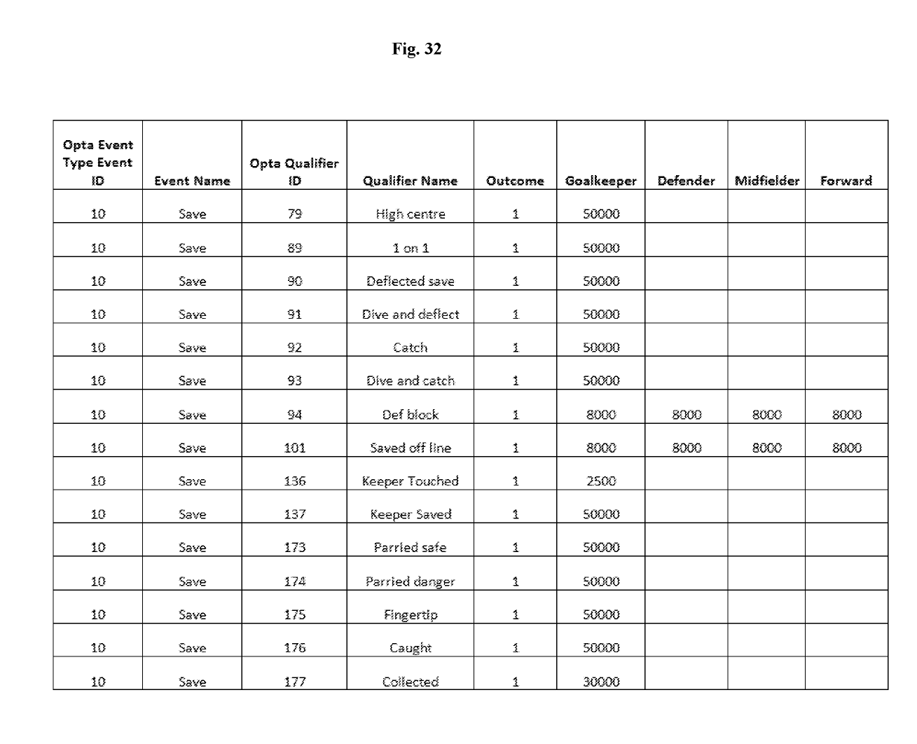

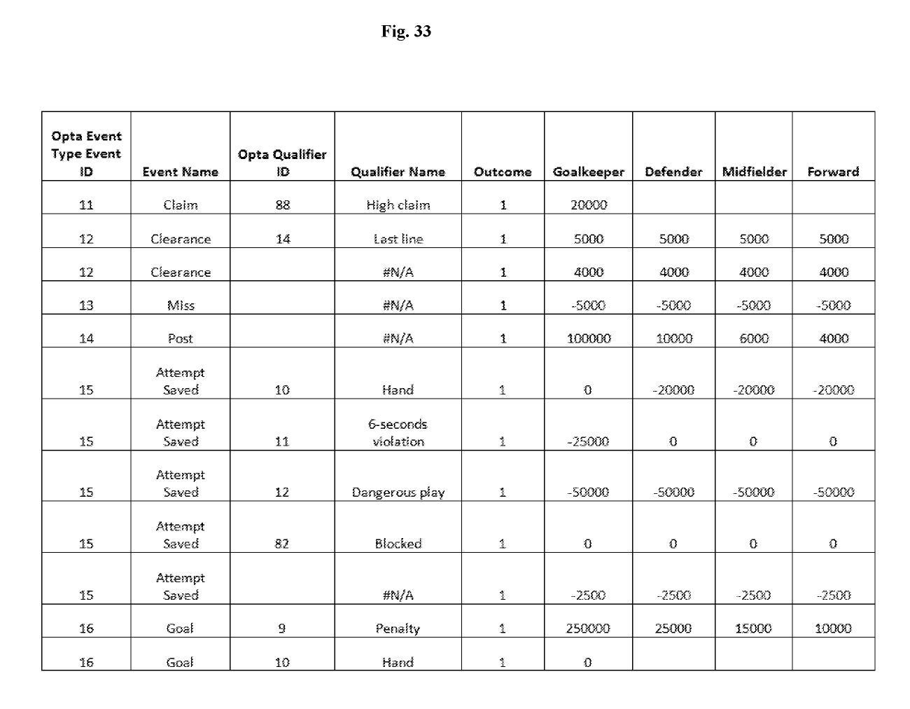

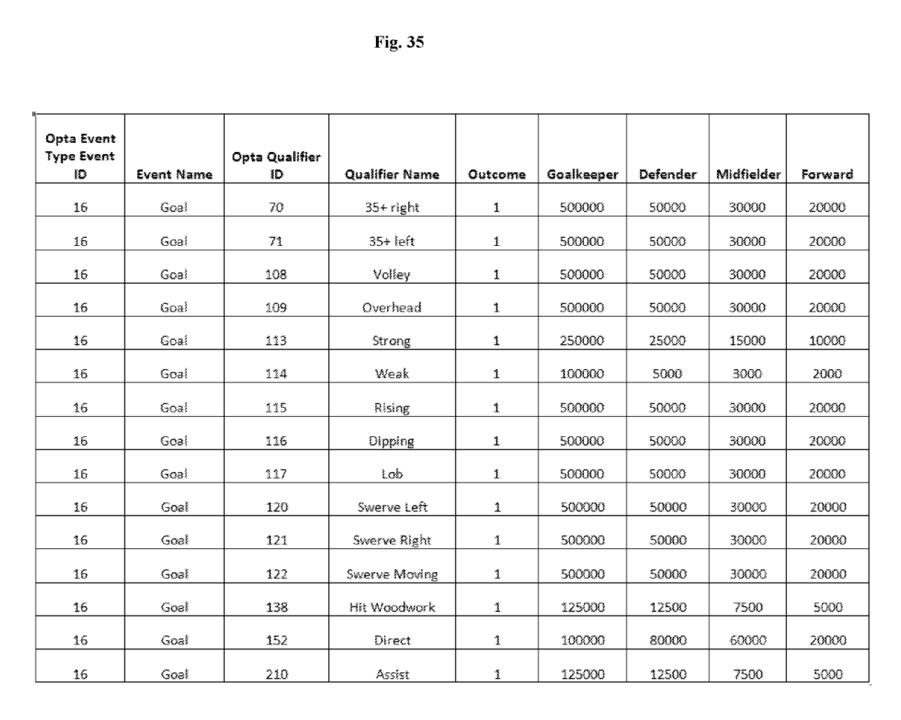

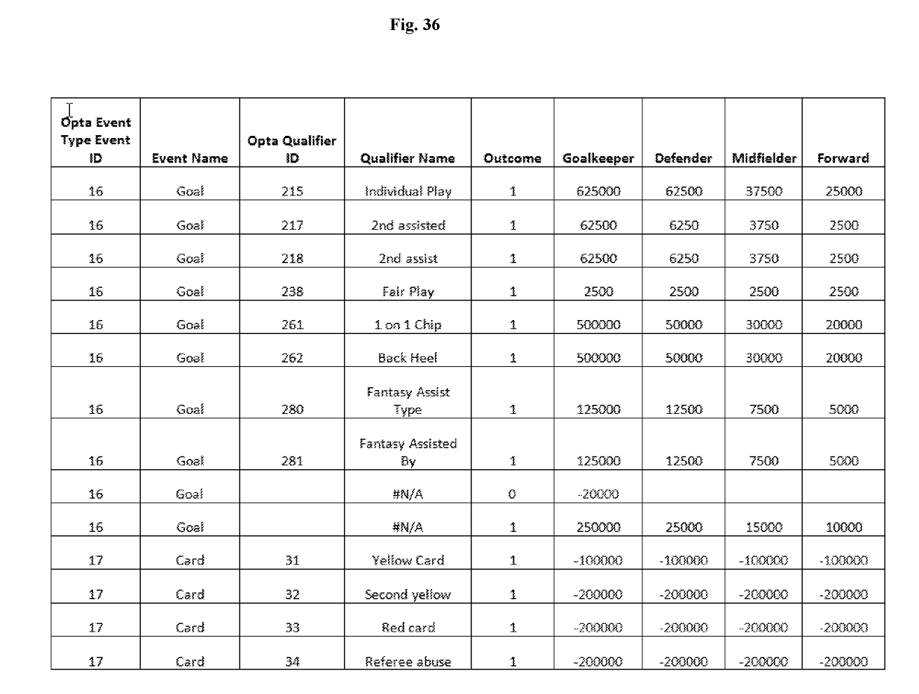

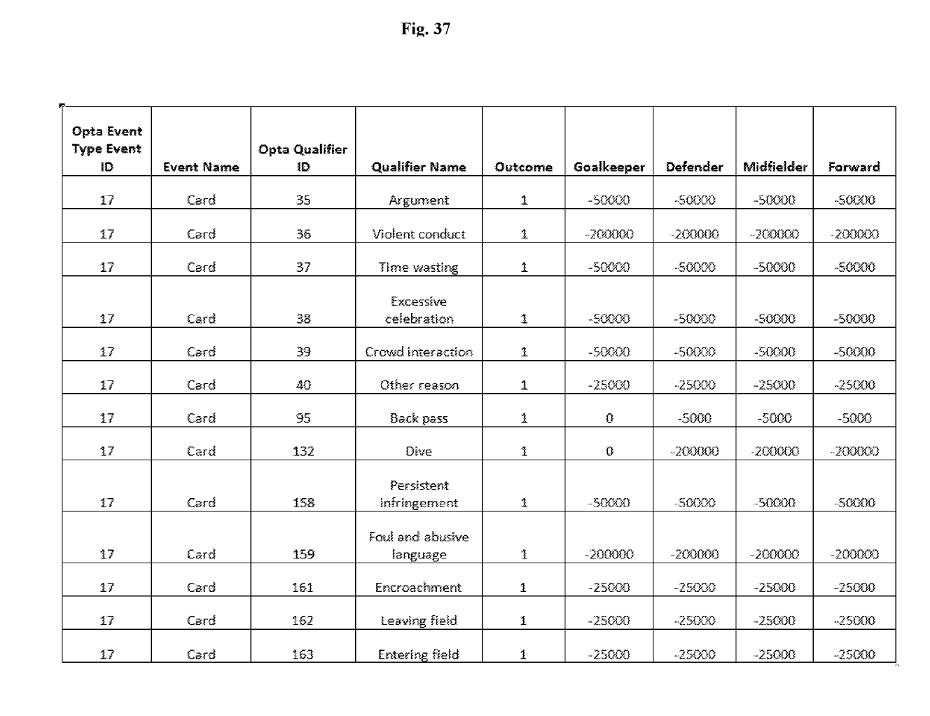

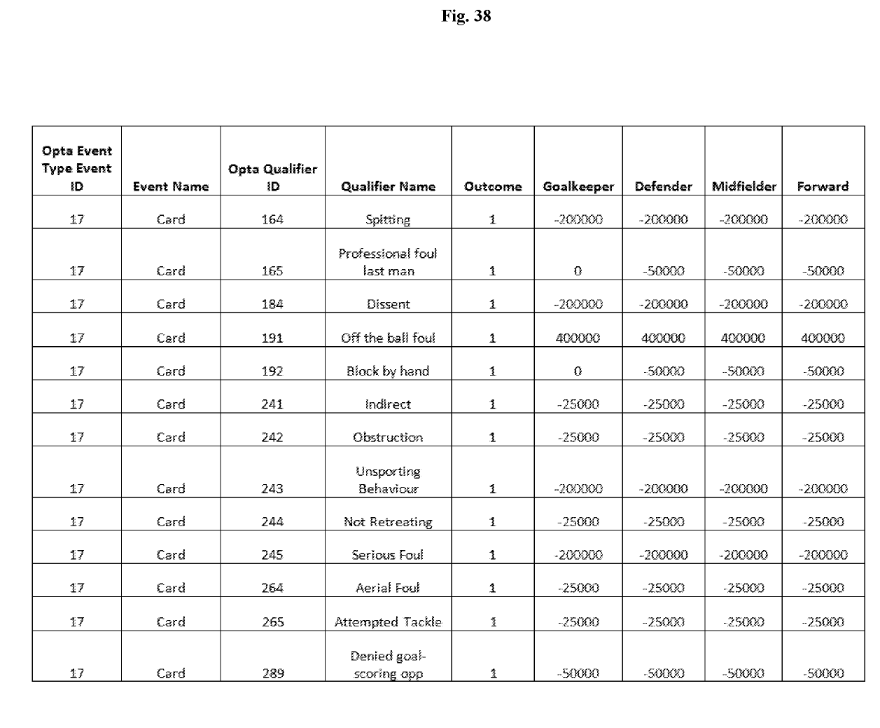

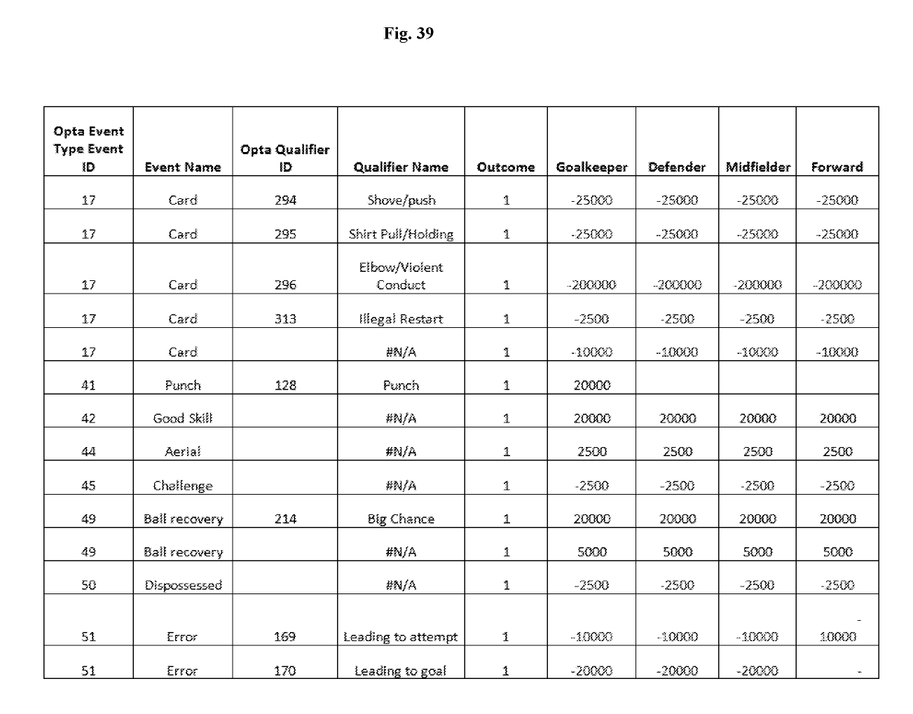

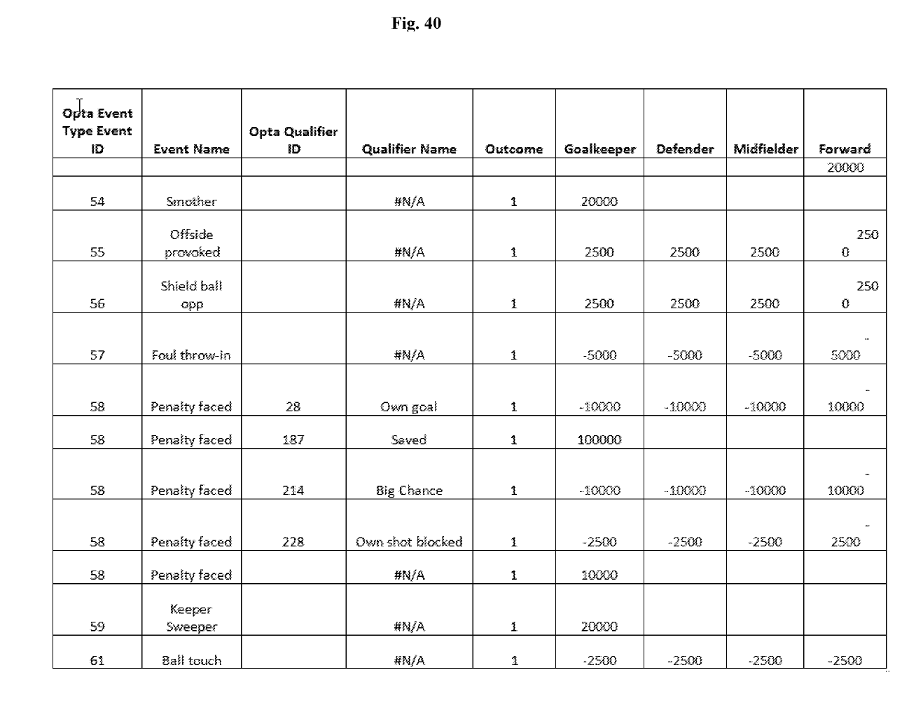

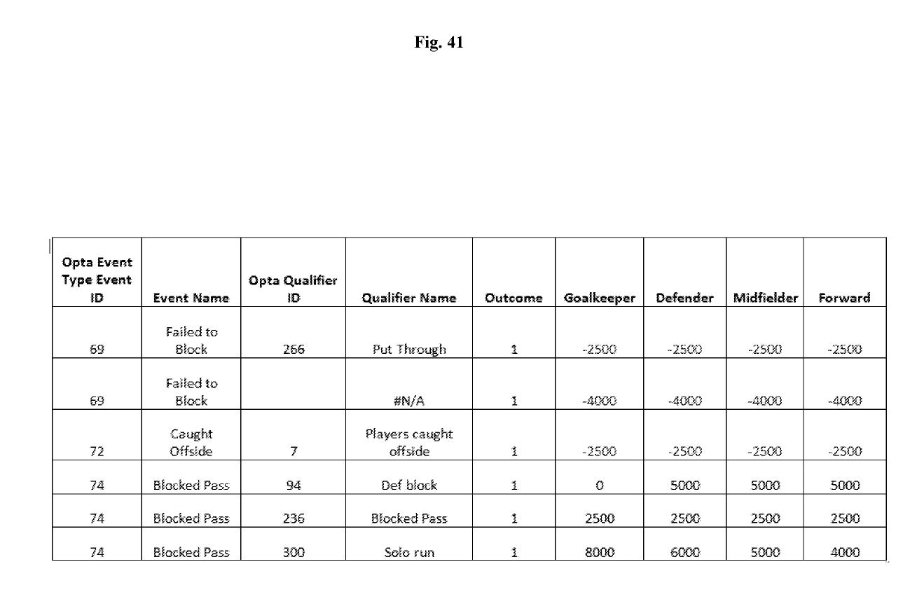

Referring to FIGS. 30-41, in particular embodiments, scoring rules comprise events and qualifiers names and respective scoring points of each event and qualifier for goalkeepers, defenders, midfielders and forwards.

In some embodiments, a software module is configured to allow a user to view the performance of each player of the selected team in different aspects of the game.

### Sporting Event Wagering Game/How to Play

The platforms, systems, media, and methods described herein include a sporting event wagering game, or use of the same. In some embodiments, a software module is configured to allow a user to choose different players as selected game-players for sub-periods of a live sporting event and get awarded scoring points based on selected game-players' performance during those assigned sub-periods.

In some embodiments, the live sporting event is a soccer game. In further embodiments, users watch live soccer matches, select one of two teams and make “wagers” on different players of the selected team, one player at a time. The data on the performance of selected player is acquired via a third-party provider (such as Opta). The data relates to approximately 80 individual events (goal, foul, shot, chance, tackle etc) that happen in a game—that are linked to individual players and time stamped (example 1.34 minutes). The presented social wagering application gives these events a unique score, which underpin how the game works. Events generate positive and negative point values.

In further embodiments, the purpose of the game is to select a total of 18 players in a 90 minute soccer game. 5 mins each player User can only choose 1 player 2 times per game (once per half). When the user holds a player, they score positive and negative points based on live data events (goal, foul, assist, pass, free kick). To get started, the user just needs to pick the first player before the start of the match (for its first 5 minutes). They need to pick the 2nd player by the 4th minute; and they need to pick the 3rd minute by the 9th minute (leaving 1 minute spare).

In some embodiments, the social wagering game involves real money. In some embodiments, the social wagering game does not involve real money.

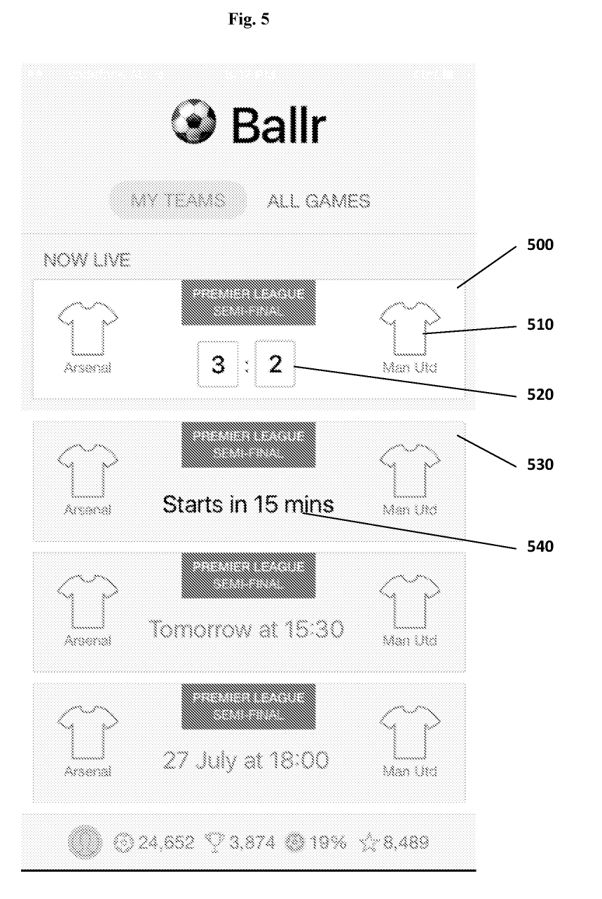

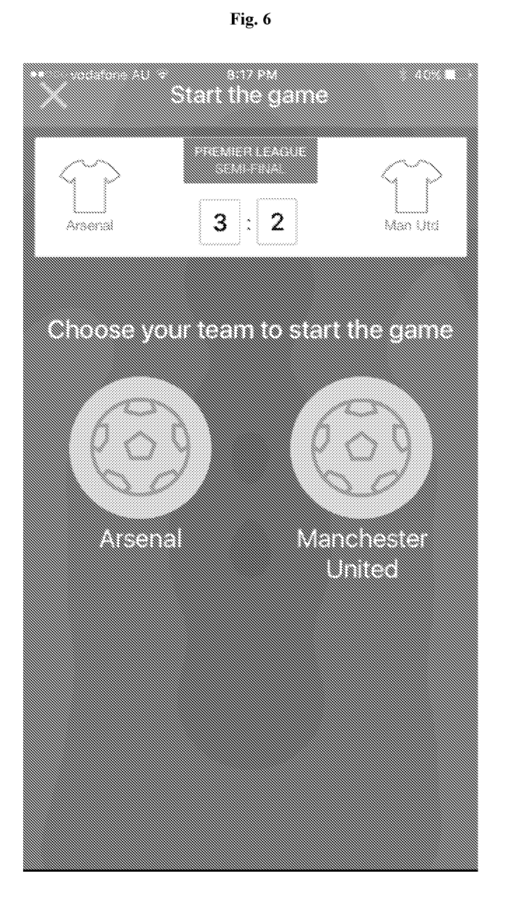

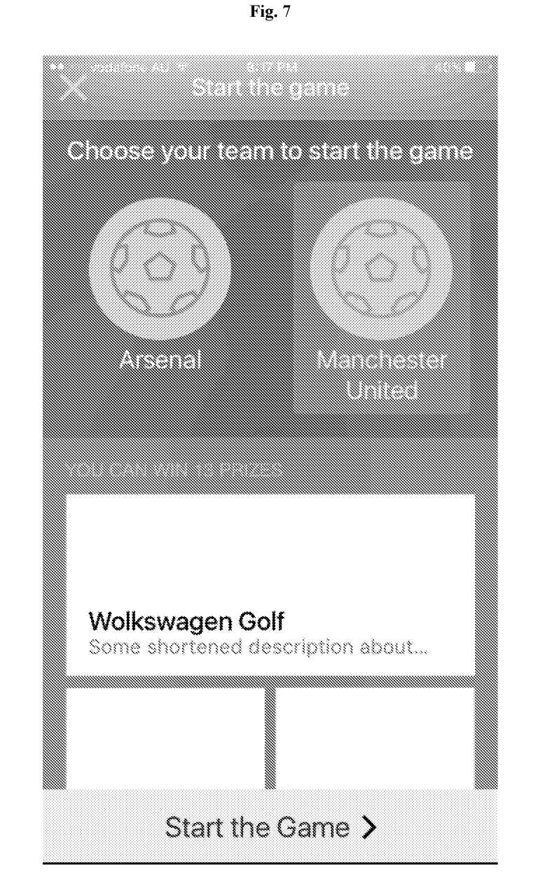

In some embodiments, a social wagering application comprises a software module configured to allow a user to create, update, and manage a player account. In further embodiments, a social wagering application comprises a software module configured to allow the user to choose a favorite sporting team and to follow one or more other sporting teams wherein a sporting team comprises two or more players. In further embodiments, a social wagering application comprises a software module configured to allow the user to choose from in-play or upcoming sporting events of a selected sporting team to play a social wagering game. Referring to FIG. 5, in a particular embodiment, an interface is provided to allow a user to view and choose from in-play sporting events 500 and upcoming sporting events 520. A team 510 is displayed iconographically and by name for each event. For in-play events, a current score 520 is displayed. For upcoming sporting events, the amount of time until the event begins 540 is displayed. Referring to FIG. 6, in a particular embodiment, an interface is provided to allow a user to choose a team for a live sporting event. Referring to FIG. 7, in a particular embodiment, an interface is provided to allow a user to choose a team for a live sporting event and start a social wagering game.

In some embodiments, a social wagering application comprises a software module configured to divide the whole playing period of the chosen sporting event into sub-periods and to allow the user to choose players as selected game-players for each sub-period. In some embodiments, a social wagering application comprises a software module configured to retrieve scoring information from a database storing scoring rules parameters comprising player-events occurred during sporting events and positive or negative scoring points for each player-event, wherein scoring points are varied for players playing at different positions. In some embodiments, a social wagering application comprises a software module configured to award points to the user upon the chosen game-player's all positive and negative scoring player-events during each sub-period, and to calculate the user's total points for the whole chosen sporting event based on the sum of awarded points to the user of all sub-periods. In some embodiments, a social wagering application comprises a software module configured to rank the user among all users of the chosen sporting event based on the total points, and to award the user one or more of prizes, experiences and wagering tokens based on the user's ranking.

In some embodiments, a software module is configured to allow a user to invite social networking media friends to join the social wagering application. In some embodiments, a software module is configured to allow a user to play a chosen sporting event against participating friends and to rank the player based on the awarded points among the said participating friends. Referring to FIG. 8, in a particular embodiment, an interface is provided to allow a user to invite friends to play social wagering game on a live sporting event.

For example, a player logs in and enters the app for a social wagering application. The player is provided interfaces to see upcoming sporting events, the next upcoming sporting events, and live sporting events.

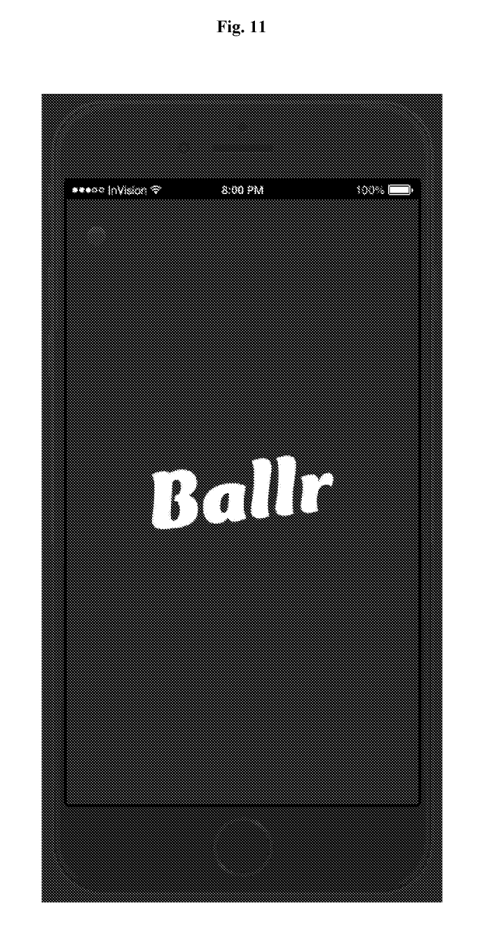

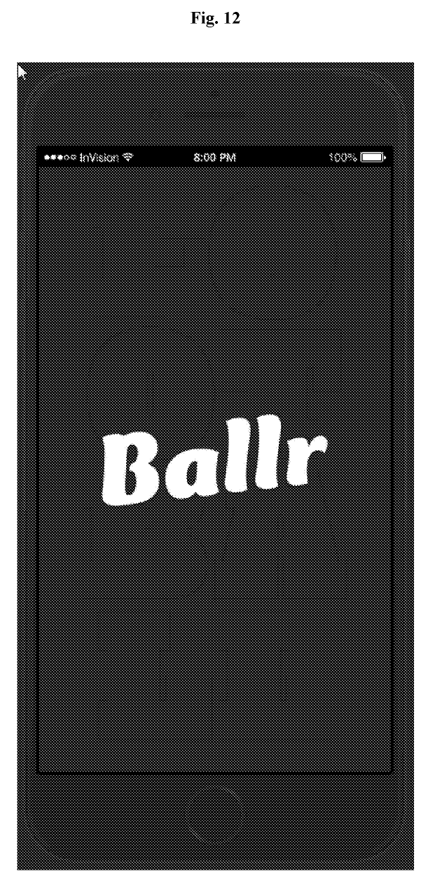

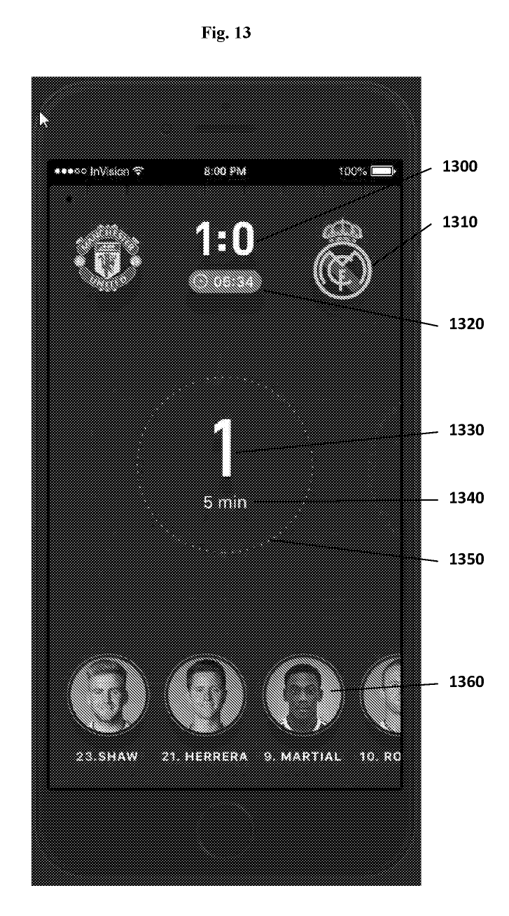

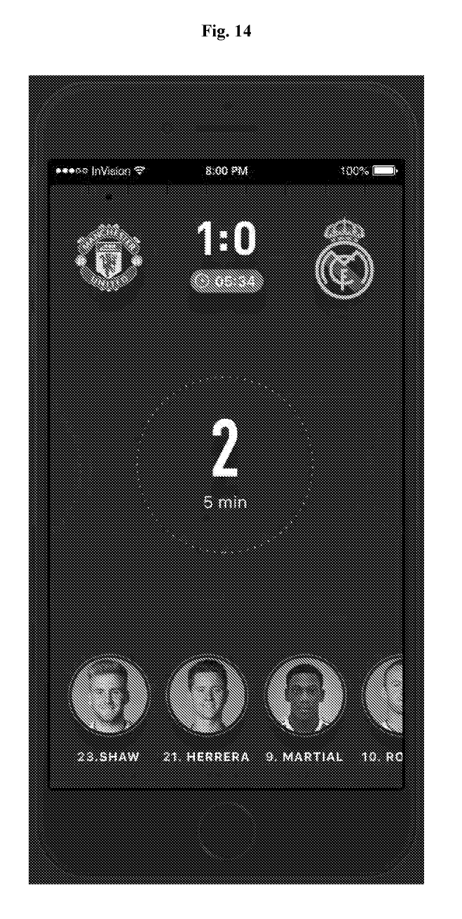

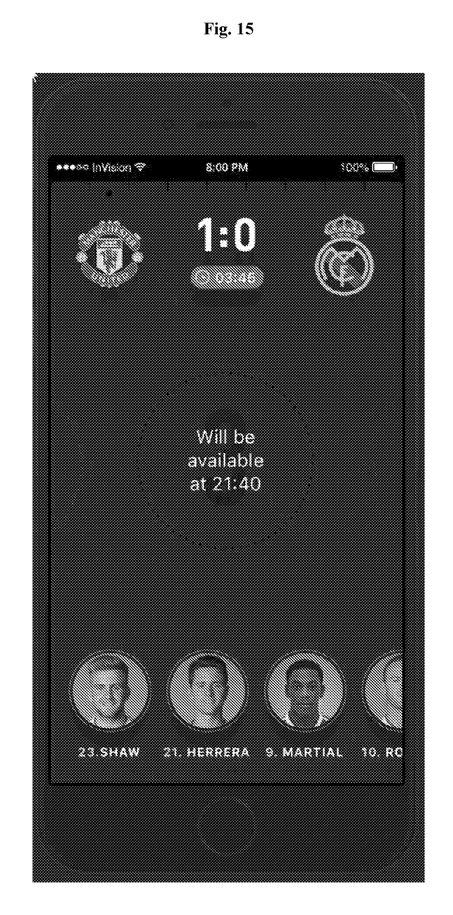

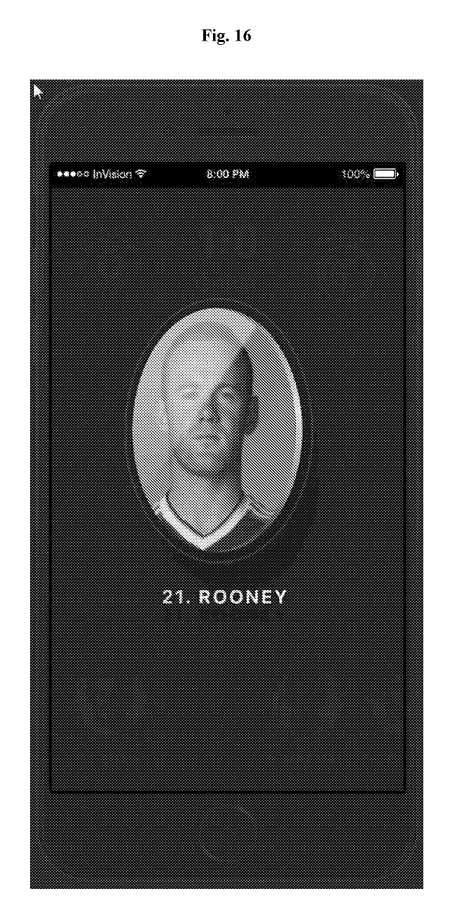

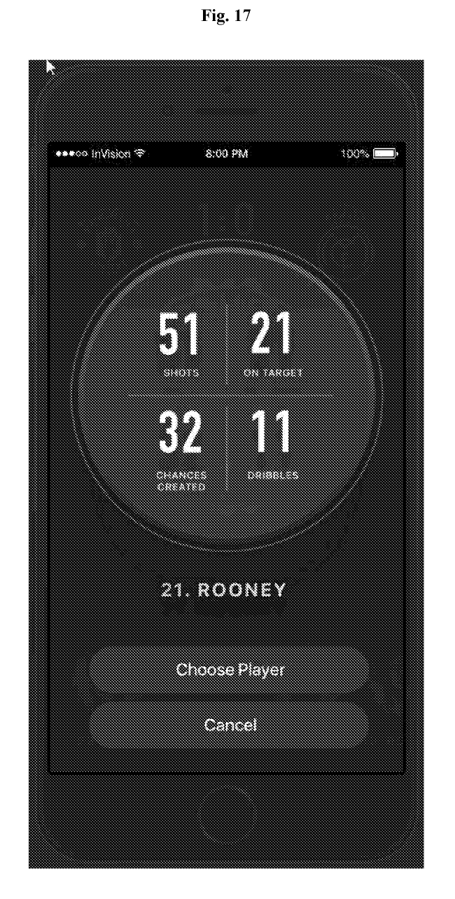

Referring to FIGS. 11 and 12, in particular embodiments, loading interfaces are provided for game playing screens. Referring to FIG. 13, in a particular embodiment, an interface is provided to allow a user to choose a player for the first 5-minute sub-period. The interface displays an icon 1310 for each opposing team in the event, the current score 1300, and the total time elapsed 1320 in the event. The number of sub-period 1330 and duration of the sub-period 1340 are displayed. A dashed border 1350 indicates that a player has not yet been selected for the indicated sub-period. Players available for selection 1360 are displayed. Referring to FIG. 14, in a particular embodiment, an interface is provided to allow a user to choose a player for the second 5-minute sub-period. Referring to FIG. 15, in a particular embodiment, an interface is provided to allow a user to choose a game-player for the third 5-minute sub-period at a future time. Referring to FIG. 16, in a particular embodiment, an interface is provided to display a game-player chosen for the next 5-minute sub-period. Referring to FIG. 17, in a particular embodiment, an interface is provided to display a chosen player's playing performance for a finished sub-period.

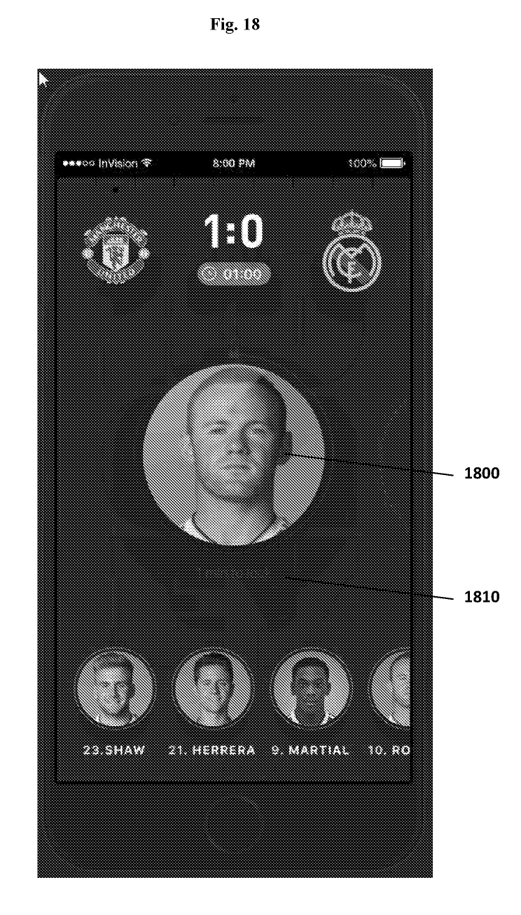

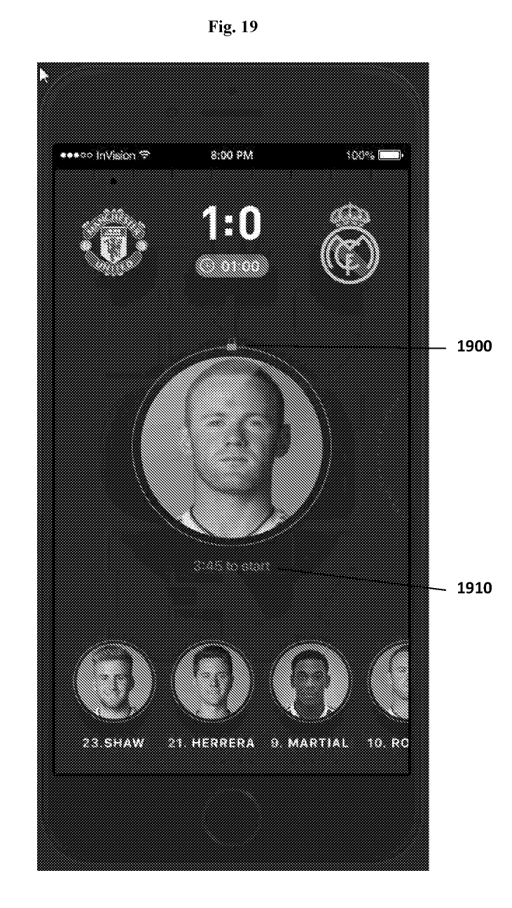

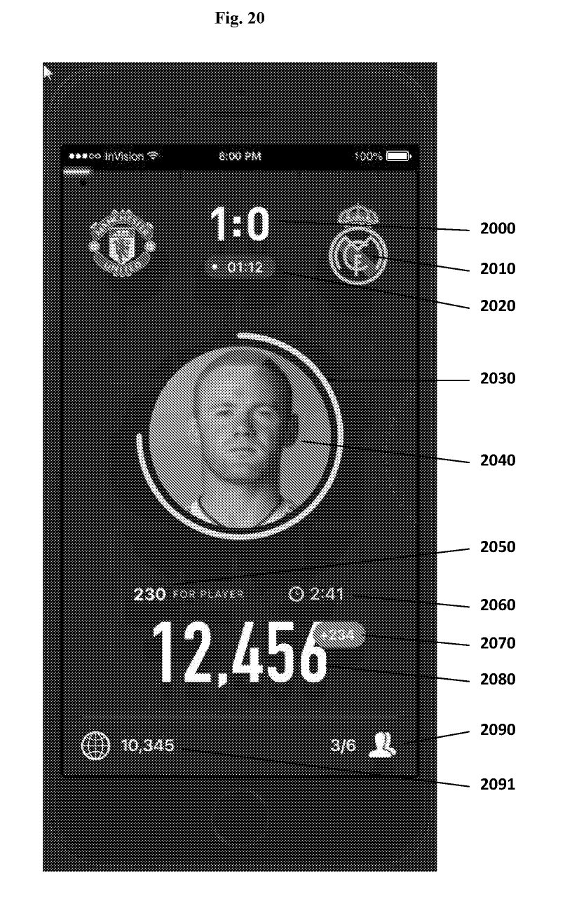

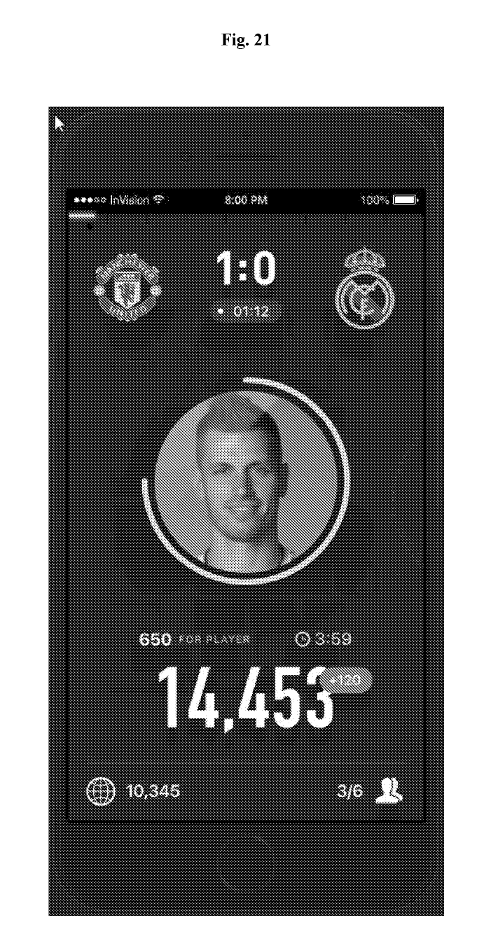

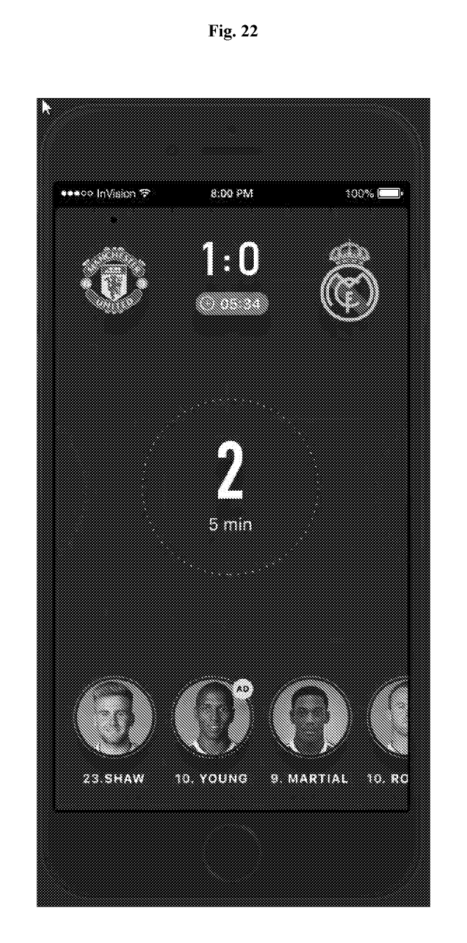

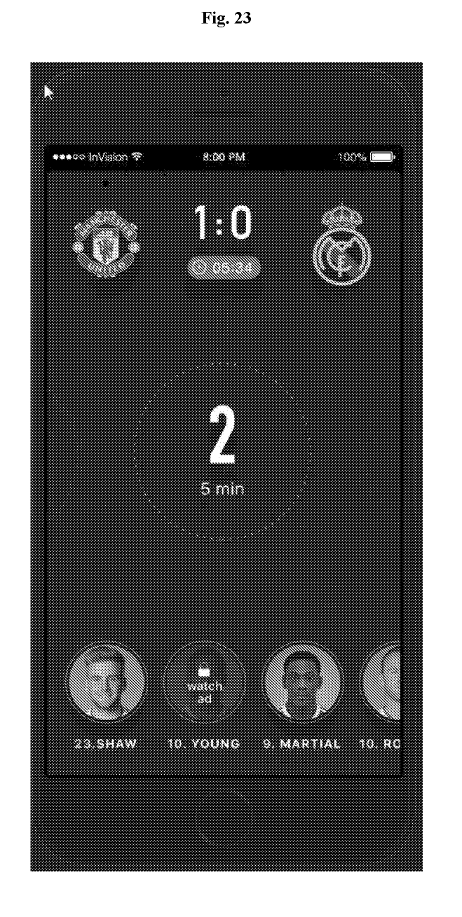

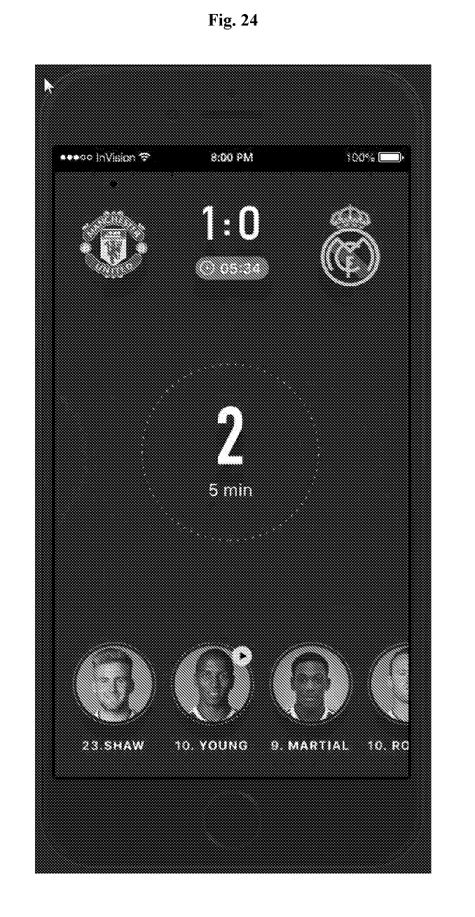

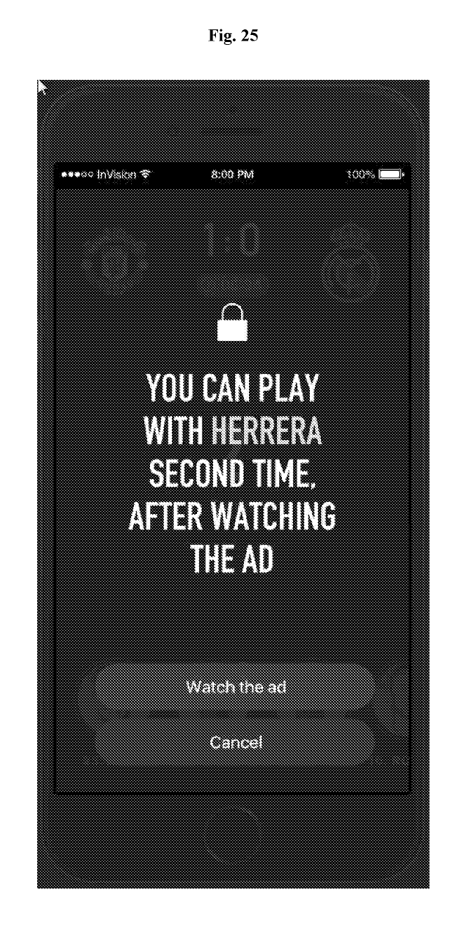

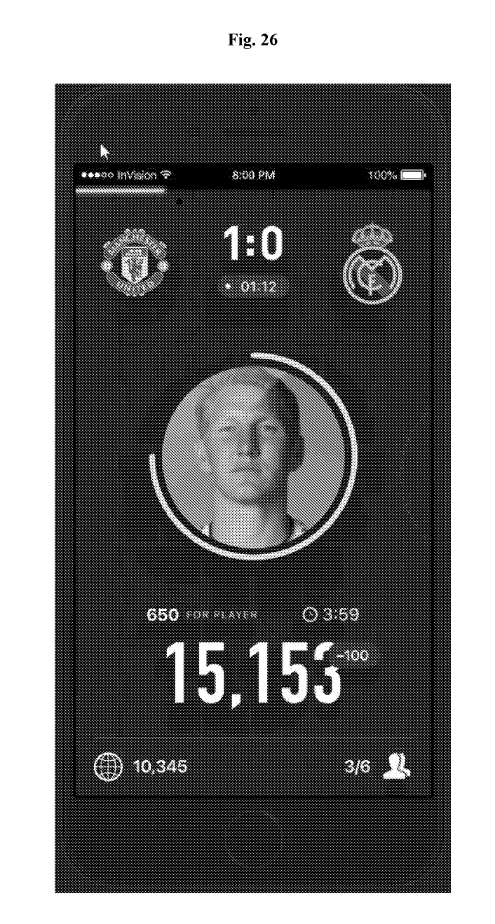

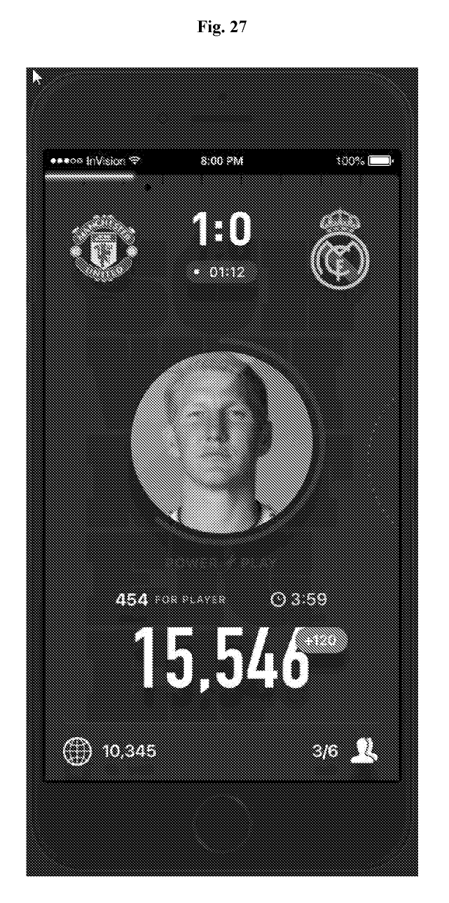

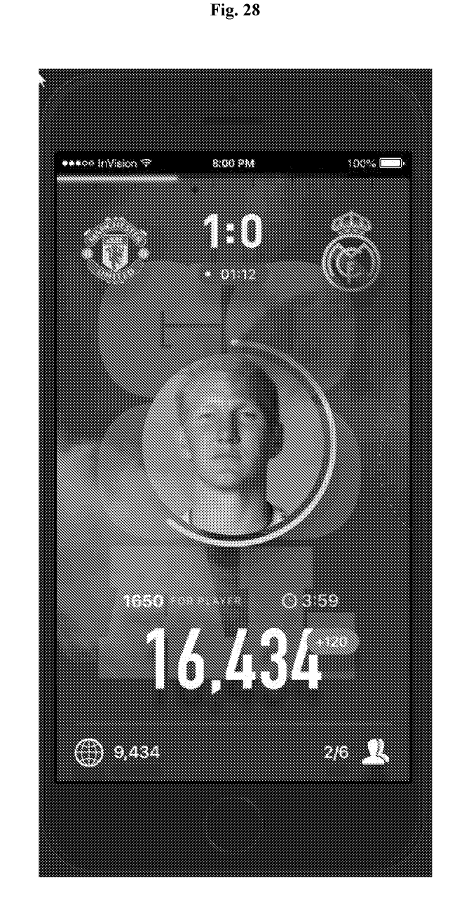

Referring to FIG. 18, in a particular embodiment, an interface is provided to allow a user to choose and lock a player for a sub-period. A player portrait 1800 for the selected player is displayed, as well as the time remaining 1810 to lock a player for the sub-period. Referring to FIG. 19, in a particular embodiment, an interface is provided to display a locked player waiting for the player's assigned sub-period. A lock icon 1900 surrounding the player portrait indicates that the user has locked in the player for the sub-period. A timer 1910 displays the time until the sub-period for which the player was selected begins. Referring to FIG. 20, in a particular embodiment, an interface is provided to display a chosen player's live playing performance during the player's assigned sub-period. Statistics for the sporting event, the chosen player, and the user are displayed. The score 2000 and total time elapsed 2020 for the sporting event are displayed. Icons 2010 for each of the teams in the sporting event are displayed. A player portrait 2040 for the chosen player for the current sub-period is displayed. A progress bar 2030 displays graphically how much time in the chosen player's sub-period has elapsed. Also displayed are the total points 230 earned by the chosen player, the time elapsed 2060 in the current sub-period, the user's total points 2080 for the event, and points 2070 awarded to the user as result of a recent player event. Also displayed are the user's global ranking 2091 and the user's ranking 2090 among a group of friends. Referring to FIG. 21, in a particular embodiment, an interface is provided to display another chosen player's live playing performance during the player's assigned sub-period. Referring to FIG. 22, in a particular embodiment, an interface is provided to allow a user to choose a player for the second 5-minute sub-period wherein an ad needs to be displayed before that player is viewed and chosen. Referring to FIGS. 23-25, in particular embodiments, interfaces are provided to allow a user to watch an ad video before choosing a certain player for the second time during one live sporting event. Referring to FIGS. 26-28, in particular embodiments, interfaces are provided to display a chosen player's different live playing performance and scoring points during the player's assigned sub-period.

The purpose of the game is to be at the top of the leaderboard with the most points by the end of the game. In some embodiments, a software module is configured to rank a user among all players of the chosen sporting event based on the total points, and to award a user one or more of prizes, experiences and wagering tokens based on the user's ranking. For example, depending on the match in play, prizes, experiences and match tokens and awarded to those in the top 10-30% of all players. In some embodiments, a software module is configured to allow a user to play a chosen sporting event against participating friends and to rank the user based on the awarded points among the said participating friends. Finally, if a player is successful, he will be notified via the app and the server team will arrange a prize for the player.

In some embodiments, a software module is configured to allow a user to view the performance of each player of the selected team in different aspects of the game.

In some embodiments, a user plays the social wagering game while he is at a private community; for example, a 500-people bar. In some embodiments, a user plays the social wagering game while he is at a stadium of 100,000 people. In some embodiments, a software module is configured to allow a user to enter this “stadium” environment within the social wagering environment with a code. In further embodiments, this “stadium” environment provides a leaderboard and prizes of its own for those within this “stadium” environment. In some embodiments, a TV station is qualified as a “stadium” environment when all its viewers receive a code from the TV station. In further embodiments, a user enters into a private game while using the code from the TV station.

### Scoring Points and Rankings

The platforms, systems, media, and methods described herein include scoring points, or use of the same. In some embodiments, a database is configured to store scoring rules parameters comprising player-events occurred during sporting events and positive or negative scoring points for each player-event, wherein scoring points are varied for players playing at different positions. Referring to FIGS. 30-41, in particular embodiments, scoring rules comprise events and qualifiers names and respective scoring points of each event and qualifier for goalkeepers, defenders, midfielders and forwards.

In some embodiments, a software module is configured to award points to the user upon the chosen game-player's all positive and negative scoring player-events during each sub-period, and to calculate the user's total points for the whole chosen sporting event based on the sum of awarded points to the user of all sub-periods. In some embodiments, a software module is configured to rank a user among all players of the chosen sporting event based on the total points, and to award a user one or more of prizes, experiences and wagering tokens based on the player's ranking. In some embodiments, a software module is configured to allow a player to play a chosen sporting event against participating friends and to rank the user based on the awarded points among the said participating friends. In some embodiments, a user account comprises profiles which include one or more of: teams, friends, scoring points and rankings.

In some embodiments, the platforms, systems, media, and methods described herein include rankings, or use of the same. In some embodiments, a user's score for a live sporting event is ranked against leaderboard and the user's friends. In some embodiments, a user's average of total points awarded is ranked against leaderboard and the user's friends. In further embodiments, the average points would include all the games independently of the team. In some embodiments, a user's team ranking is the user's overall ranking for a specific team community. For example, a user has a ranking among all followers who have Manchester United as their favorite teams.

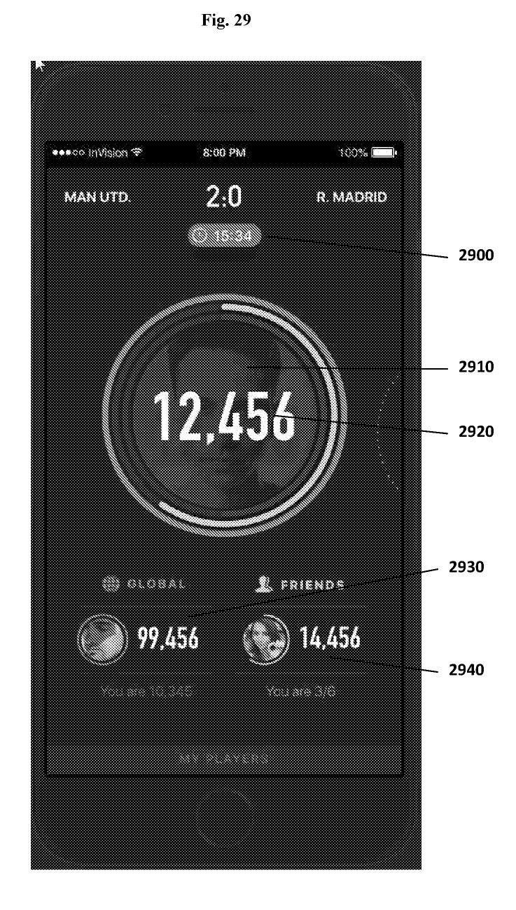

In some embodiments, a leaderboard is displayed to show all users' points and rankings, and a user's own rank among them. In some embodiments, a leaderboard is displayed to show a user's friends' points and rankings, and the user's own rank among them. Referring to FIG. 9, in a particular embodiment, an interface is configured to display a user's play information including friends, favorite and followed teams, sporting events played, average scoring points, different rankings and access to a leaderboard. Referring to FIG. 29, in a particular embodiment, a leaderboard is displayed to show all users' points and rankings, and a user's own rank among them. Time elapsed 2900 in the current event is displayed. A user's portrait 2910 and points 2920 earned in the current event are displayed. The user's total points 2930, and a friend's total points 2940 are displayed.

Referring to FIGS. 26-28, in particular embodiments, interfaces are provided to display a chosen player's different live playing performance and scoring points during the player's assigned sub-period.

### Achievements and Prizes

In some embodiments, the platforms, systems, media, and methods described herein include achievements, or use of the same. In some embodiments, a user account comprises profiles which include one or more of: achievements, friends, and play history. In some embodiments, achievements comprise one or more of prizes, experiences and wagering tokens that are awarded to a user.

In some embodiments, the platforms, systems, media, and methods described herein include prizes, or use of the same. In some embodiments, a software module is configured to rank a user among all players of the chosen sporting event based on the total points, and to award a user one or more of prizes, experiences and wagering tokens based on the user's ranking. In some embodiments, prizes include all kinds of real goods.

In some embodiments, live sporting events will have associated sponsors and prizes for highest point scorers. Admins will be able to set metadata (pictures and descriptions) for each match, highest scorers will be notified in-app on match end in case they win and will be requested additional contact info if not already stored.

### Wagering Tokens

In some embodiments, the platforms, systems, media, and methods described herein include wagering tokens, or use of the same. In some embodiments, a player is given a certain number of daily wagering tokens. In some embodiments, a player is awarded tokens as one kind of prizes. In some embodiments, a software module is configured to rank the user among all users of the chosen sporting event based on the total points, and to award the user one or more of prizes, experiences and wagering tokens based on the user's ranking. In some embodiments, a user may purchase additional wagering tokens with real money.

### Leaderboard

In some embodiments, the platforms, systems, media, and methods described herein include a leaderboard, or use of the same. In some embodiments, a leaderboard is displayed to show all users' points and rankings, and a user's own rank among them. In some embodiments, a leaderboard is displayed to show a user's friends' points and rankings, and the user's own rank among them.

In some embodiments, a user's score for a live sporting event is ranked against leaderboard and the user's friends. In some embodiments, a user's average of total points awarded is ranked against leaderboard and the user's friends. In further embodiments, the average points would include all the games independently of the team. In some embodiments, a user's team ranking is the user's overall ranking for a specific team community. For example, a user has a ranking among all followers who have Manchester United as their favorite teams.

In some embodiments, at any stage of a live sporting event users is configured to see how they are performing against the global community (per team per match) and also among their Facebook friends that selected the same team. In some embodiments, the real-time updates of the leaderboard are required. In some embodiments, the real-time updates of the leaderboard are not required. In further embodiments, leaderboards may be updated once per each 5-minute period after it's completed.

Referring to FIG. 9, in a particular embodiment, an interface is configured to display a user's play information including friends, favorite and followed teams, sporting events played, average scoring points, different rankings and access to a leaderboard. Referring to FIG. 29, in a particular embodiment, a leaderboard is displayed to show all users' points and rankings, and a user's own rank among them.

### Power-Play

In some embodiments, the platforms, systems, media, and methods described herein include a power-play, or use of the same. In some embodiments, during a power-play, double points are awarded for similar player-events. In some embodiments, power-play is an element of fun in the game to encourage people to return to the app during a match.

For example, in a particular embodiment of soccer game, when the game starts 1 of the 9 segments of the first half is called “Power Play;” and it is the same in the second half. In this period, the user receives double points. For example, 5 minutes before power play starts the user receives notification: “Power Play will be in the 7th segment, 3540 mins. Double points.”

### Ads

In some embodiments, the platforms, systems, media, and methods described herein include ads, or use of the same. In some embodiments, within the game screen there is room for banner advertisements. In further embodiments, banner advertisements are customized at team level. In further embodiments, banner advertisements are customized by the social wagering system and are different from sporting teams' partners.

In some embodiments, ads are required to be viewed by a user before he can choose a player as selected game-player. In further embodiments, incentivized ads are required to “energize” an already used player to be used again as a game-player. Referring to FIG. 22, in a particular embodiment, an interface is provided to allow a user to choose a player for the second 5-minute sub-period wherein an ad needs to be displayed before that player is viewed and chosen. Referring to FIGS. 23-25, in particular embodiments, interfaces are provided to allow a user to watch an ad video before choosing a certain player for the second time during one live sporting event.

### Purchased Players

In some embodiments, the platforms, systems, media, and methods described herein include a purchased player, or use of the same. In some embodiments, the user is allowed to purchase premium players as selected game-players using scoring points awarded. Accordingly, the newly purchased premium players would gain more points for the user; which in turn will give the user more leverage to purchase more premium players. This points-purchase loop emulates a healthy operation like what a real soccer club, such as Barcelona and Real Madrid would do.

### Digital Processing Device

In some embodiments, the platforms, systems, media, and methods described herein include a digital processing device, or use of the same. In further embodiments, the digital processing device includes one or more hardware central processing units (CPUs) or general purpose graphics processing units (GPGPUs) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony®PS3®, Sony®PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In yet other embodiments, the display is a head-mounted display in communication with the digital processing device, such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

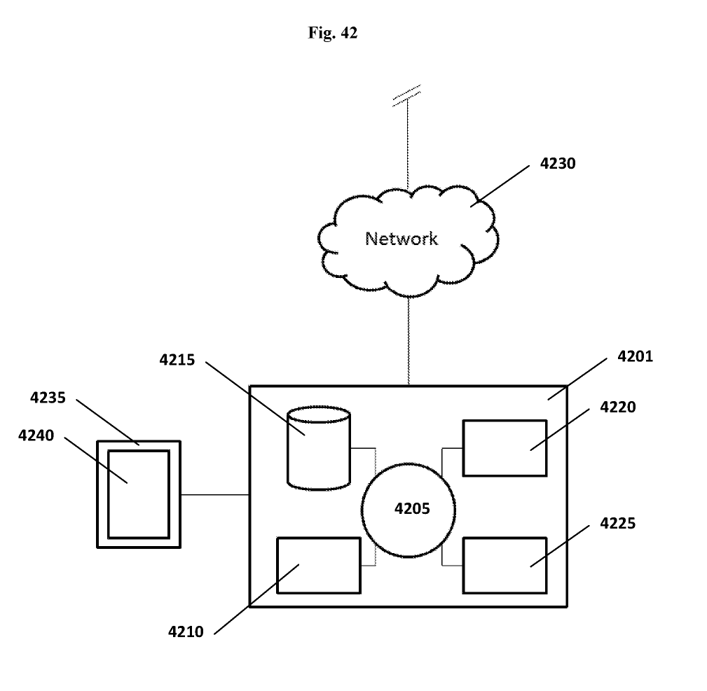

Referring to FIG. 42, in a particular embodiment, an exemplary digital processing device 4201 is programmed or otherwise configured to create a social wagering application for live sporting events. In this embodiment, the digital processing device 4201 includes a central processing unit (CPU, also “processor” and “computer processor” herein) 4205, which can be a single core or multi core processor, or a plurality of processors for parallel processing. The digital processing device 4201 also includes memory or memory location 4210 (e.g., random-access memory, read-only memory, flash memory), electronic storage unit 4215 (e.g., hard disk), communication interface 4220 (e.g., network adapter) for communicating with one or more other systems, and peripheral devices 4225, such as cache, other memory, data storage and/or electronic display adapters. The memory 4210, storage unit 4215, interface 4220 and peripheral devices 4225 are in communication with the CPU 4205 through a communication bus (solid lines), such as a motherboard. The storage unit 4215 can be a data storage unit (or data repository) for storing data. The digital processing device 4201 can be operatively coupled to a computer network (“network”) 4230 with the aid of the communication interface 4220. The network 4230 can be the Internet, an internet and/or extranet, or an intranet and/or extranet that is in communication with the Internet. The network 4230 in some cases is a telecommunication and/or data network. The network 4230 can include one or more computer servers, which can enable distributed computing, such as cloud computing. The network 4230, in some cases with the aid of the device 4201, can implement a peer-to-peer network, which may enable devices coupled to the device 4201 to behave as a client or a server.

Continuing to refer to FIG. 42, the CPU 4205 can execute a sequence of machine-readable instructions, which can be embodied in a program or software. The instructions may be stored in a memory location, such as the memory 4210. The instructions can be directed to the CPU 4205, which can subsequently program or otherwise configure the CPU 4205 to implement methods of the present disclosure. Examples of operations performed by the CPU 4205 can include fetch, decode, execute, and write back. The CPU 4205 can be part of a circuit, such as an integrated circuit. One or more other components of the device 4201 can be included in the circuit. In some cases, the circuit is an application specific integrated circuit (ASIC) or a field programmable gate array (FPGA).

Continuing to refer to FIG. 42, the storage unit 4215 can store files, such as drivers, libraries and saved programs. The storage unit 4215 can store user data, e.g., user preferences and user programs. The digital processing device 4201 in some cases can include one or more additional data storage units that are external, such as located on a remote server that is in communication through an intranet or the Internet.

Continuing to refer to FIG. 42, the digital processing device 4201 can communicate with one or more remote computer systems through the network 4230. For instance, the device 4201 can communicate with a remote computer system of a user. Examples of remote computer systems include personal computers (e.g., portable PC), slate or tablet PCs (e.g., Apple® iPad, Samsung® Galaxy Tab), telephones, Smart phones (e.g., Apple® iPhone, Android-enabled device, Blackberry®), or personal digital assistants.

Methods as described herein can be implemented by way of machine (e.g., computer processor) executable code stored on an electronic storage location of the digital processing device 4201, such as, for example, on the memory 4210 or electronic storage unit 4215. The machine executable or machine readable code can be provided in the form of software. During use, the code can be executed by the processor 4205. In some cases, the code can be retrieved from the storage unit 4215 and stored on the memory 4210 for ready access by the processor 4205. In some situations, the electronic storage unit 4215 can be precluded, and machine-executable instructions are stored on memory 4210.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight ®, Java™, and Unity®.

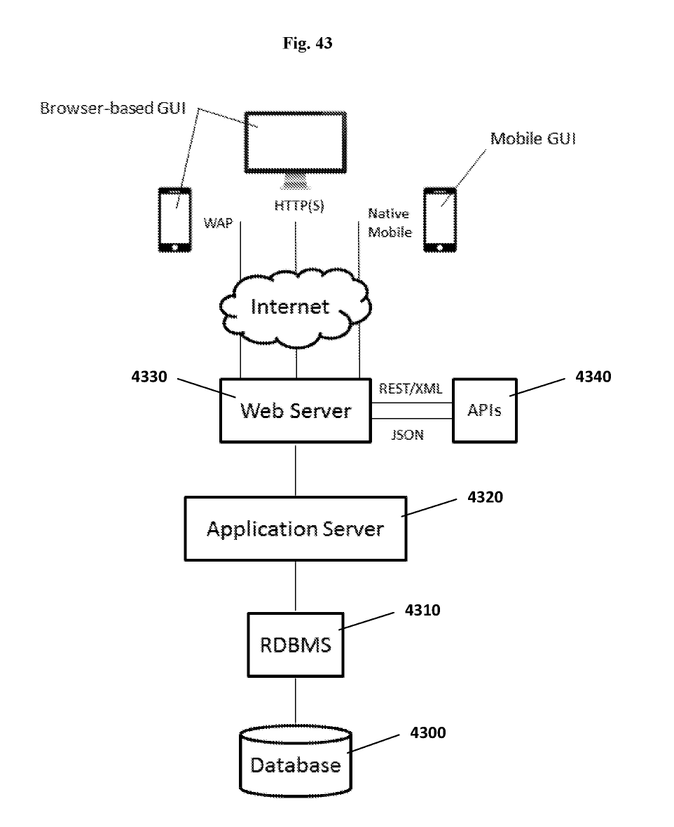

Referring to FIG. 43, in a particular embodiment, an application provision system comprises one or more databases 4300 accessed by a relational database management system (RDBMS) 4310. Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application severs 4370 (such as Java servers, .NET servers, PHP servers, and the like) and one or more web servers 4330 (such as Apache, IIS, GWS and the like). The web server(s) optionally expose one or more web services via app application programming interfaces (APIs) 4340. Via a network, such as the Internet, the system provides browser-based and/or mobile native user interfaces.

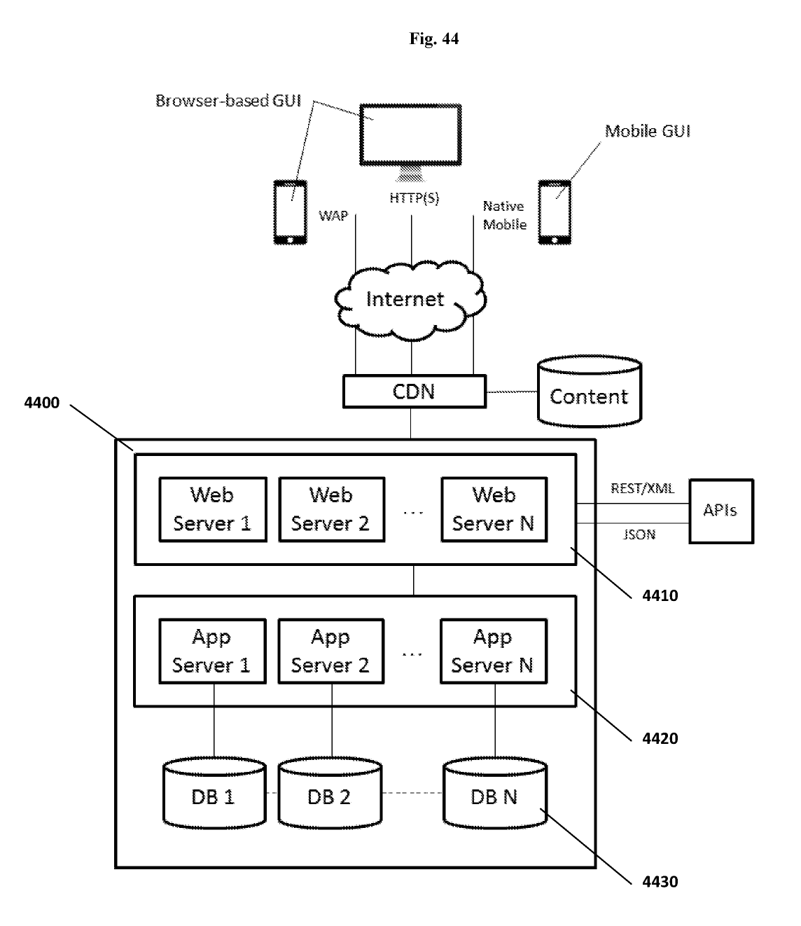

Referring to FIG. 44, in a particular embodiment, an application provision system alternatively has a distributed, cloud-based architecture 4400 and comprises elastically load balanced, auto-scaling web server resources 4410 and application server resources 4420 as well synchronously replicated databases 4430.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome Web Store, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of user storage, game storage, leaderboard storage, and sport storage information. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In other embodiments, a database is based on one or more local computer storage devices.

### Example 1—User Selection of a Sporting Event and Players and Participation in a Social Wagering Game

A user who is a soccer fan wishing to participate in social wagering for a soccer match opens the Ballr app on her smartphone while viewing the match. The app displays currently live and upcoming soccer matches, and the user selects an upcoming match which is about to begin. The app prompts the user to select one of the two teams participating in the match, and the user selects the team whose players' the user wishes to wager on. Having selected a team, the app prompts the user with a list of the user's friends, and the user selects several friends from the list, after which the app sends to those friends' invitations to participate in the wagering event.

As the match is about to begin, the user selects and locks in a player from her chosen team's roster for the first 5 minute sub-period of the match. For the duration of the sub-period, the user is awarded points based player's performance in the match, giving the soccer fan motivation to root for the chosen player to perform well in the game beyond the player's mere contribution to the final outcome of the match. As the match progresses, the user selects a remaining player from her chosen team's roster for each of the 5-minute sub periods, and points awarded to the user for the each of these chosen players' performances are added to the user's point total for the match. As the match progresses, the player can view through the app her point total as compared to the point totals for each of her invited friends, allowing her to see her ranking among her friends in real time. For sub-periods after the match half-time, the user is allowed to choose a player that was chosen in first half of the match, so that each player on her chosen team may be selected a total twice during the match: once before halftime and once after halftime. Limiting selection of each player to only once per half of the match prevents the player from simply choosing the best player on the field for every period, and forces the user to use her knowledge of each of the players and the game to predict how well many of the players will perform over the course of the match. At the conclusion of the match, the player's total points for the match are ranked against other participants wagering on the soccer match. The app displays the user's total points, her ranking among her invited friends, and her ranking among global participants for that match. The user does extremely well, having been awarded more total points than any of her friends, providing her satisfaction at having accurately predicted which players would perform well during the selected sub-periods of the match. As a reward for ranking first place among her friends, the app awards her bonus wagering tokens that she may use to wager on future soccer matches.

### Example 2—Calculation of User's Points During a Sub Period

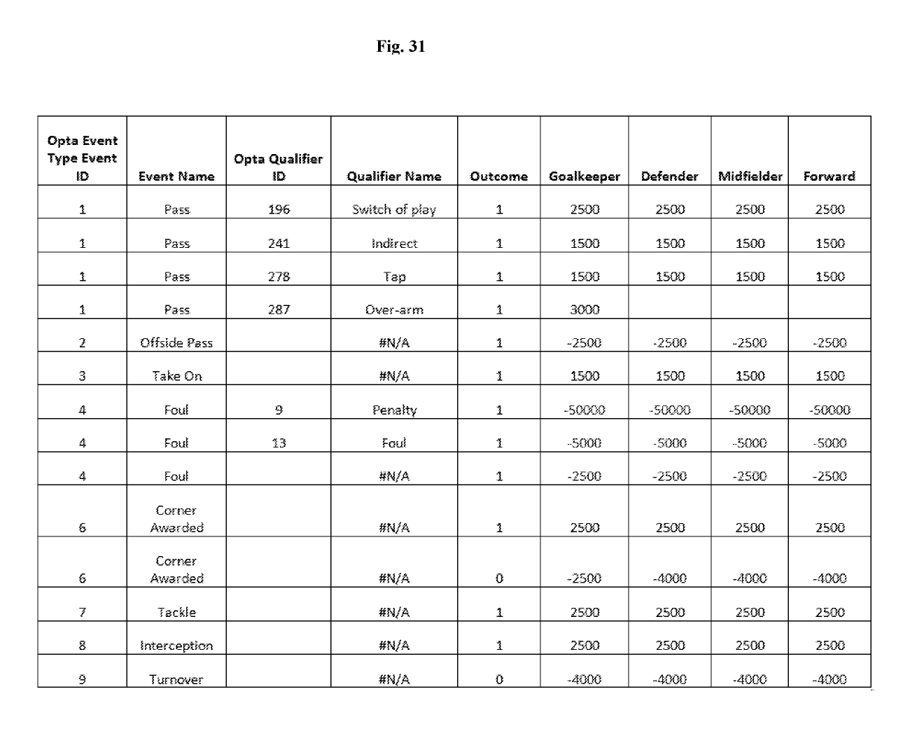

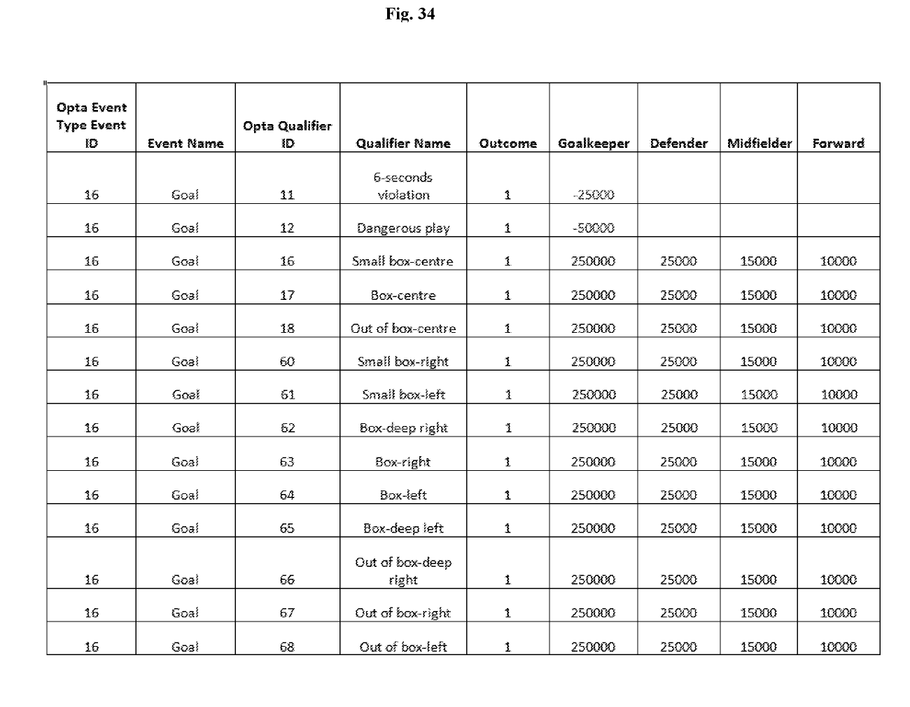

During the course of a soccer match, a user participating in social wagering through the Ballr app chooses a player for the first 5-minute sub-period of the match. During the course of the sub period, the chosen player successfully completes a head pass. According to the scoring rules shown in FIG. 30, the player, who is a forward, earns +4000 points for this player event. These 4000 points are awarded to the player and added to her point total for the soccer match. The app updates the user's total score in real time, notifying the user that a player event for which points have been awarded has occurred, and showing the event type, the points awarded for the event, the chosen players total points for the sub-period, and the user's updated total points for the match as a whole. Later, during the same 5-minute sub-period, the chosen player commits a turnover. According to the scoring rules in FIG. 31, a turnover committed by a forward results in the player earning −4000 points. In real time, the app notifies the user of this player event, and deducts 4000 points from the user's point total for the match. Later, within the same 5-minute sub-period, the chosen player scores a goal from outside the goal box on the right side of the playing field. According to the scoring rules in FIG. 34, this is categorized as “Goal” event, with an “out of box—right” qualifier name, for which a forward earns 10,000 points. In real time, the app notifies the user of this player event, and adds 10,000 points to the user's point total for the match. The 5-minute sub-period expires without the chosen player performing any additional actions that qualify as scoring player-events according to the scoring rules. Thus, at the conclusion of the first 5-minute sub-period, the user is has been awarded a total of 10,000 points, representing the sum of all points awarded for all scoring player-events by the chosen player that occurred during the first sub-period.

1. A computer-implemented social wagering system, comprising: a digital processing device comprising: at least one processor, an operating system configured to perform executable instructions, a memory, and a computer program including instructions executable by the digital processing device to create a social wagering application for live sporting events comprising:
a) a software module configured to allow a user to create, update, and manage a user account;
b) a software module configured to allow the user to choose a favorite sporting team and to follow one or more other sporting teams wherein a sporting team comprises two or more players;
c) a software module configured to allow the user to choose from in-play or upcoming sporting events of a selected sporting team to play a social wagering game;
d) a software module configured to divide the whole playing period of the chosen sporting event into sub-periods and to allow the user to choose players as selected game-players for each sub-period;
e) a database storing scoring rules parameters comprising player-events occurred during sporting events and positive or negative scoring points for each player-event, wherein scoring points are varied for players playing at different positions;
f) a software module configured to award points to the user upon the chosen game-player's all positive and negative scoring player-events during each sub-period, and to calculate the user's total points for the whole chosen sporting event based on the sum of awarded points to the user of all sub-periods; and
g) a software module configured to rank the user among all users of the chosen sporting event based on the total points, and to award the user one or more of prizes, experiences and wagering tokens based on the user's ranking.

2. The system of claim 1, wherein each player is allowed to be chosen as a game-player only once for all sub-periods of one sporting event.

3. The system of claim 1, wherein each player is allowed to be chosen as a game-player no more than twice for all sub-periods of one sporting event.

4. The system of claim 1, wherein each player is allowed to be chosen as a game-player three times or more for all sub-periods of one sporting event.

5. The system of claim 1, wherein a user account comprises profiles which include one or more of: teams, friends, scoring points and rankings.

6. The system of claim 1, wherein a user creates a log-in account through the social wagering application.

7. The system of claim 1, wherein a user creates a log-in account using a social networking media account.

8. The system of claim 7, wherein the social networking media account is imported from one or more of: Facebook, YouTube, Twitter, LinkedIn, Pinterest, Google Plus+, Tumblr, Instagram, Reddit, VK, Snapchat, Flickr, Vine, Meetup, Ask.fm, Classmates, QQ, WeChat, Swarm by Foursquare, Kik, Yik Yak, Shots, Periscope, Medium, Soundcloud, Tinder, WhatsApp, Slack, Musical.ly, Peach, Blab, Email, Message, Renren, Sina Weibo, Renren, Line, and Momo.

9. The system of claim 7, wherein the system further comprising a software module configured to allow a user to invite social networking media friends to join the social wagering application.

10. The system of claim 1, wherein the system further comprising a software module configured to allow a user to play a chosen sporting event against participating friends and to rank the user based on the awarded points among the said participating friends.

11. The system of claim 1, wherein the user is allowed to choose game-players ahead of an upcoming sporting event.

12. The system of claim 1, wherein the user is allowed to choose game-players during an ongoing sporting event before each sub-period.

13. The system of claim 1, wherein the player-events of the sporting event comprising one or more of: event score, event run, and any determinable event results.

14. The system of claim 1, wherein a leaderboard is displayed to show all user's points and rankings, and a player's own rank among them.

15. The system of claim 1, wherein a leaderboard is displayed to show a user's friends' points and rankings, and the user's own rank among them.

16. The system of claim 1, wherein suitable sporting events comprise one or more of: cricket, baseball, basketball, volleyball, American football, softball, soccer, handball, ice hockey, field hockey, lacrosse, water polo, and rugby.

17. The system of claim 1, wherein the sporting event is a soccer game.

18. The system of claim 17, wherein the sporting event is divided into 5-minute sub-periods, and the user is allowed to choose different game-players for every 5-minute sub-period.

19. The system of claim 17, wherein a player is allowed to be chosen twice for each half of the soccer game.

20. The system of claim 17, wherein a player is listed as one of the positions of: a goalkeeper, a defender, a midfielder, and a forward.

21. The system of claim 17, wherein player-events comprising one or more of: pass, offside pass, take on, foul, corner awarded, tackle, interception, turnover, save, claim, clearance, miss, post, attempt saved, goal, card, punch, good skill, aerial, challenge, ball recovery, error, smother, offside provoked, shield ball opp, foul throw-in, penalty faced, keeper sweeper, ball touch, failed to block, caught offside, blocked offside, and blocked pass.

22. The system of claim 21, wherein player-events are awarded respective scoring points upon the position of a game-player.

23. The system of claim 21, wherein player-events are identified by one or more specific qualifiers.

24. The system of claim 23, wherein each specific qualifier connected with player-events is awarded respective scoring points upon the position of a game-player.

25. The system of claim 1, wherein ads are displayed to the user at different sporting event breaks.

26. The system of claim 1, wherein the user is allowed to purchase players as selected game-players using scoring points awarded.

27. Non-transitory computer-readable storage media encoded with a computer program including instructions executable by a processor to create a social wagering application for live sporting events comprising:
a) a software module configured to allow a user to create, update, and manage a user account;
b) a software module configured to allow the user to choose a favorite sporting team and to follow one or more other sporting teams wherein a sporting team comprises two or more players;
c) a software module configured to allow the user to choose from in-play or upcoming sporting events of a selected sporting team to play a social wagering game;
d) a software module configured to divide the whole playing period of the chose sporting event into sub-periods and to allow the user to choose players as selected game-players for each sub-period;
e) a database storing scoring rules parameters comprising player-events occurred during sporting events and positive or negative scoring points for each player-event, wherein scoring points are varied for players playing at different positions;
f) a software module configured to award points to the user upon the chosen game-player's all positive and negative scoring player-events during each sub-period, and to calculate the user's total points for the whole chosen sporting event based on the sum of awarded points to the user of all sub-periods; and
g) a software module configured to rank the user among all users of the chosen sporting event based on the total points, and to award the user one or more of prizes, experiences and wagering tokens based on the user's ranking.

28.-52. (canceled)

53. A computer-implemented method of creating a social wagering application for live sporting events comprising:
a) providing, by a computer, an interface configured to allow a player to create, update, and manage a player account;
b) providing, by the computer, an interface configured to allow the player to choose a favorite sporting team and to follow one or more other sporting teams wherein a sporting team comprises two or more players;
c) providing, by the computer, an interface configured to allow the player to choose from in-play or upcoming sporting events of a selected sporting team to play a social wagering game;
d) providing, by the computer, an interface configured to divide the whole playing period of the chosen sporting event into sub-periods and to allow the user to choose players as selected game-players for each sub-period;
e) retrieving, by the computer, information from a database storing scoring rules parameters comprising player-events occurred during sporting events and positive or negative scoring points for each player-event, wherein scoring points are varied for players playing at different positions;
f) providing, by the computer, an interface configured to award points to the user upon the chosen game-player's all positive and negative scoring player-events during each sub-period, and to calculate the user's total points for the whole chosen sporting event based on the sum of awarded points to the user of all sub-periods; and
g) providing, by the computer, an interface configured to rank the user among all user of the chosen sporting event based on the total points, and to award the user one or more of prizes, experiences and wagering tokens based on the user's ranking.

54.-78. (canceled)
